(19) United States
(12) Patent Application Publication
(10) Pub. No.: US 2025/0045074 A1
(43) Pub. Date: Feb. 6, 2025

(54) INFORMATION PROCESSING APPARATUS AND CONTROL METHOD

(71) Applicant: Lenovo (Singapore) Pte. Ltd., Singapore (SG)

(72) Inventor: Yoshinori Ito, Kanagawa (JP)

(73) Assignee: Lenovo (Singapore) Pte. Ltd., Singapore (SG)

(21) Appl. No.: 18/766,989

(22) Filed: Jul. 9, 2024

(30) Foreign Application Priority Data
Aug. 3, 2023 (JP) 2023-127319

(51) Int. Cl. G06F 9/451; G06F 3/0481

(52) U.S. Cl. CPC G06F 9/451; G06F 3/0481; G06F 2203/04803

(57) ABSTRACT

An information processing apparatus includes: a display; a memory which stores a program of an application; and a processor which executes the program of the application stored in the memory to perform control to display a window of the application on the display. The processor performs display mode switching processing to control switching between a first display mode in which display is controlled using an entire screen area of the display as one display area, and a second display mode in which display is controlled by splitting the screen area of the display into multiple display areas, and display control processing to display thumbnail images corresponding to at least some of windows of running applications in any one of the multiple display areas with a window hidden therefrom due to a fact that the window being displayed in the display area in the second display mode is hidden.

### CROSS-REFERENCE TO RELATED APPLICATIONS

This application claims priority to Japanese Patent Application No. 2023-127319 filed on Aug. 3, 2023, the contents of which are hereby incorporated herein by reference in their entirety.

### TECHNICAL FIELD

The present invention relates to an information processing apparatus and a control method.

### BACKGROUND

In recent years, there is an information processing device having multiple screens (for example, two screens). For example, there is disclosed an information processing device with a two-screen structure having two displays (display units) respectively equipped in a first chassis and a second chassis foldable through a coupling part (hinge mechanism) (for example, see Japanese Unexamined Patent Application Publication No. 2015-233198). Further, there is an information processing device with a flexible display (display unit) such as an organic EL display provided over a first chassis and a second chassis to be bendable according to the folding of the information processing device (for example, see Japanese Unexamined Patent Application Publication No. 2018-013850). Even when one display (display unit) is provided over the first chassis and the second chassis in this way, it is possible not only to use the one display as a one-screen mode but also to use the one display as a two-screen mode in a pseudo manner by splitting the one display into a display area on the side of the first chassis and a display area on the side of the second chassis. Even in the information processing device with the two-screen structure by the two displays described above, it is also possible to use the two displays not only in the two-screen mode but also in the one-screen mode using the two displays as one screen.

For example, in Japanese Unexamined Patent Application Publication No. 2022-070081, there is disclosed an information processing device in which, in response to switching from the one-screen mode to the two-screen mode related to the display of windows of running applications, an active window in the one-screen mode is displayed on one of the two screens, and thumbnail images corresponding to windows other than the active window are displayed on the other screen. Since this information processing device can make it easier not only to continue using an application used in the one-screen mode when switching from the one-screen mode to the two-screen mode, but also to check thumbnail images as a list of other running applications, it is convenient. A user can perform an operation to select a thumbnail image so as to display and use a window of an application corresponding to the selected thumbnail image.

However, for example, in the technology disclosed in Japanese Unexamined Patent Application Publication No. 2022-070081 described above, the window of the application that the user wants to use can be displayed by performing the operation to select the thumbnail image, but it is not easy to close the window and switch further to a window of another application. When the display is used by splitting the display into three or more display areas in addition to the two-screen mode, since the number of windows to be displayed in each display area further increases, it is desirable to be able to select a window to be displayed in each display area more easily.

### SUMMARY

One or more embodiments of the present invention provide an information processing apparatus and a control method to improve operability when selecting windows to be displayed in multiple display areas, respectively.

An information processing apparatus according to one or more embodiments of the present invention includes: a display; a memory which stores a program of an application; and a processor which executes the program of the application stored in the memory to perform control to display a window of the application on the display, wherein the processor performs display mode switching processing to control switching between a first display mode in which display is controlled using the entire screen area of the display as one display area, and a second display mode in which display is controlled by splitting the screen area of the display into multiple display areas, and display control processing to display thumbnail images corresponding to at least some of windows of running applications in any one of the multiple display areas with a window hidden therefrom due to the fact that the window being displayed in the display area in the second display mode is hidden.

The above information processing apparatus may be such that, when the window being displayed in any one of the multiple display areas in the second display mode is hidden and when there no other window to be displayed in the display area with the window hidden therefrom, the processor displays, by the display control processing, the thumbnail images in the display area with the window hidden therefrom.

The above information processing apparatus may also be such that, when switching from the first display mode to the second display mode by the display mode switching processing, the processor displays one window among the windows of the applications running in the first display mode in a first display area among the multiple display areas by the display control processing, and displays, in a second display area except the first display area among the multiple display areas, the thumbnail images corresponding to windows except the one window among the windows in the first display mode.

The above information processing apparatus may further be such that, when switching from the first display mode to the second display mode by the display mode switching processing, the processor minimizes, by the display control processing, the windows except the one window among the windows in the first display mode.

Further, the above information processing apparatus may be such that, when switching from the first display mode to the second display mode by the display mode switching processing, the processor arranges, in the first display area, and then minimizes the windows except the one window among the windows in the first display mode by the display control processing.

Further, the above information processing apparatus may be such that, when any one of the thumbnail images is selected with a user operation, the processor hides all the thumbnail images displayed in the second display area, and displays a window corresponding to the selected thumbnail image in the second display area.

Further, the above information processing apparatus may be such that, when displaying the thumbnail images by the display control processing due to the fact that the window being displayed in any one of the multiple display areas in the second display mode is hidden, the processor displays the thumbnail images except a window being displayed on the top layer in any one of the multiple display areas among the windows of all the running applications.

Further, the above information processing apparatus may be such that, when displaying the thumbnail images by the display control processing due to the fact that the window being displayed in any one of the multiple display areas in the second display mode is closed and hidden, the processor excludes, from display targets, a thumbnail image corresponding to the window closed and hidden.

Further, the above information processing apparatus may be such that, when displaying the thumbnail images by the display control processing due to the fact that the window being displayed in any one of the multiple display areas in the second display mode is hidden, the processor displays the thumbnail images corresponding to the windows of all the running applications.

Further, a control method according to one or more embodiments of the present invention is a control method for an information processing apparatus including: a display; a memory which stores a program of an application; and a processor which executes the program of the application stored in the memory to perform control to display a window of the application on the display, the control method including: a display mode switching step of causing the processor to control switching between a first display mode in which display is controlled using the entire screen area of the display as one display area, and a second display mode in which display is controlled by splitting the screen area of the display into multiple display areas; and a display control step of causing the processor to display thumbnail images corresponding to at least some of windows of running applications in any one of the multiple display areas with a window hidden therefrom due to the fact that the window being displayed in the display area in the second display mode is hidden.

The above-described aspects of the present invention can improve operability when selecting windows to be displayed in multiple display areas, respectively.

### BRIEF DESCRIPTION OF THE DRAWINGS

FIG. 1 is a perspective view illustrating the appearance of an information processing apparatus according to one or more embodiments.

FIG. 2 is a side view illustrating an example of the information processing apparatus in a bent state according to one or more embodiments.

FIG. 3 is a side view illustrating an example of the information processing apparatus in a flat state according to one or more embodiments.

FIG. 4 is a diagram illustrating specific examples of various display modes of the information processing apparatus according to one or more embodiments.

FIGS. 5(A)-(C) are diagrams illustrating an example of operation specifications of display mode switching operations according to one or more embodiments.

FIG. 6 is a diagram illustrating a display example of a two-screen mode according to one or more embodiments.

FIGS. 7(A)-(D) are diagrams illustrating a first example of thumbnail window display control according to one or more embodiments.

FIGS. 8(A)-(D) are diagrams illustrating a second example of thumbnail window display control according to one or more embodiments.

FIG. 9 is a block diagram illustrating a hardware configuration example of the information processing apparatus according to one or more embodiments.

FIG. 10 is a block diagram illustrating a functional configuration example related to display control processing according to one or more embodiments.

FIG. 11 is a flowchart illustrating an example of display control processing upon switching to the two-screen mode according to one or more embodiments.

FIG. 12 is a flowchart illustrating an example of display control processing when a window is hidden according to one or more embodiments.

FIGS. 13(B)-(C) are diagrams illustrating an example of operation specifications of display mode switching operations according to one or more embodiments.

FIGS. 14(A)-(B) are diagrams illustrating a first example of thumbnail window display control in a three-screen mode according to one or more embodiments.

FIGS. 15(A)-(B) are diagrams illustrating a second example of thumbnail window display control in the three-screen mode according to one or more embodiments.

FIG. 16 is a diagram illustrating an example of thumbnail window display control in a four-screen mode according to one or more embodiments.

### DETAILED DESCRIPTION

Embodiments of the present invention will be described below with reference to the accompanying drawings.

### First Embodiment

First, an overview of a first embodiment of the present invention will be described.

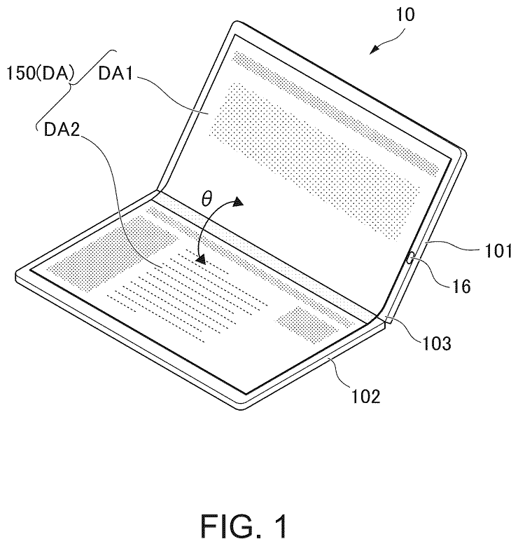

FIG. 1 is a perspective view illustrating the appearance of an information processing apparatus 10 according to one or more embodiments. The information processing apparatus 10 according to one or more embodiments is a clamshell (laptop) PC (Personal Computer). The information processing apparatus 10 includes a first chassis 101, a second chassis 102, and a hinge mechanism 103. The first chassis 101 and the second chassis 102 are chassis having a substantially rectangular plate shape (for example, a flat plate shape). One of the sides of the first chassis 101 and one of the sides of the second chassis 102 are joined (coupled) through the hinge mechanism 103 in such a manner that the first chassis 101 and the second chassis 102 are rotatable relative to each other around the rotation axis of the hinge mechanism 103. A state where an open angle θ between the first chassis 101 and the second chassis 102 around the rotation axis is substantially 0° is a state where the first chassis 101 and the second chassis 102 overlap each other and are closed. The state where the first chassis 101 and the second chassis 102 are closed is called a “closed state.” Surfaces of the first chassis 101 and the second chassis 102 on the sides to face each other in the closed state are called respective “inner surfaces,” and surfaces on the other sides of the inner surfaces are called “outer surfaces.” The open angle θ can also be called an angle between the inner surface of the first chassis 101 and the inner surface of the second chassis 102. A state opposite to the closed state, where the first chassis 101 and the second chassis 102 are open, is called an “open state.” The open state is a state where the first chassis 101 and the second chassis 102 are rotated relative to each other until the open angle θ exceeds a preset threshold value (for example, 10°).

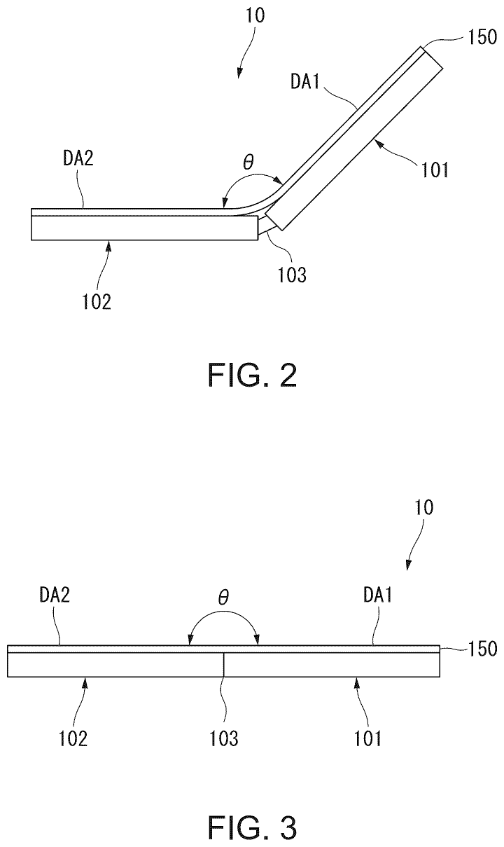

Further, the information processing apparatus 10 includes a camera 16 and a display 150. The camera 16 is provided on the inner surface of the first chassis 101. The display 150 is provided from the inner surface of the first chassis 101 to the inner surface of the second chassis 102. The camera 16 is provided, for example, in an outer part of a screen area of the display 150 on the inner surface of the first chassis 101 to be able to image a user and the like present on the side facing the display 150. The display 150 is a flexible display bendable to fit the open angle θ by relative rotation of the first chassis 101 and the second chassis 102 (see FIG. 2 and FIG. 3). As the flexible display, an organic EL display or the like is used. The information processing apparatus 10 can control not only the display as a one-screen structure in which the entire screen area of the display 150 is used as one display area DA, but also the display as a two-screen structure in which the screen area of the display 150 is split into two display areas of a first display area DA1 and a second display area DA2. Here, the first display area DA1 and the second display area DA2 are display areas that do not overlap each other. It is assumed here that a display area corresponding to the inner surface side of the first chassis 101 within the screen area of the display 150 is the first display area DA1, and a display area corresponding to the inner surface side of the second chassis 102 is the second display area DA2. In the following, a display mode to control the display with the one-screen structure is called a “one-screen mode,” and a display mode to control the display with the two-screen structure is called a “two-screen mode.”

Note that a touch sensor is provided on the screen area of the display 150. The information processing apparatus 10 can detect touch operations on the screen area of the display 150. A user can visually recognize the display of the display 150 provided on the respective inner surfaces of the first chassis 101 and the second chassis 102, and perform touch operations on the display 150 by putting the information processing apparatus 10 into the open state, thus enabling the use of the information processing apparatus 10.

Next, usage forms and screen modes of the information processing apparatus 10 will be described in detail. First, the usage forms of the information processing apparatus 10 are classified by the open angle θ between the first chassis 101 and the second chassis 102 into a bent state in which the first chassis 101 and the second chassis 102 are bent (Bent form), and a flat state in which the first chassis 101 and the second chassis 102 are not bent (Flat form). In the following, the state where the first chassis 101 and the second chassis 102 are bent (Bent form) is simply called the “bent state (Bent form),” and the flat state where the first chassis 101 and the second chassis 102 are not bent (Flat form) is simply called the “flat state (Flat form).” In the bent state (Bent form), the display 150 provided over the first chassis 101 and the second chassis 102 is also in the bent state. In the flat state (Flat form), the display 150 is also in the flat state.

FIG. 2 is a side view illustrating an example of the information processing apparatus 10 in the bent state (Bent form). The display 150 is arranged over (across the border between) the first chassis 101 and the second chassis 102. The screen area of the display 150 (the display area DA illustrated in FIG. 1) can be bent using a part corresponding to the hinge mechanism 103 as a crease, and on the border of this crease, a display area on the side of the first chassis 101 is illustrated as the first display area DA1, and a display area on the side of the second chassis 102 is illustrated as the second display area DA2. The display 150 is bent according to the rotation of (the open angle θ between) the first chassis 101 and the second chassis 102. The information processing apparatus 10 determines whether or not the state is the bent state (Bent form) according to the open angle θ. As an example, in the case of 10°<θ<170°, the information processing apparatus 10 determines that the state is the bent state (Bent form). This state corresponds to a usage form as a so-called clamshell mode or a book mode.

FIG. 3 is a side view illustrating an example of the information processing apparatus 10 in the flat state (Flat form). The information processing apparatus 10 typically determines that the state is the flat state (Flat form) when the open angle θ is 180°, but as an example, the information processing apparatus 10 may also determine that the state is the flat state (Flat form) when the open angle θ is in a range of 170°≤θ≤180°. For example, when the open angle θ between the first chassis 101 and the second chassis 102 is 180°, the display 150 is also in the flat state. This state corresponds to a usage form as a so-called tablet mode.

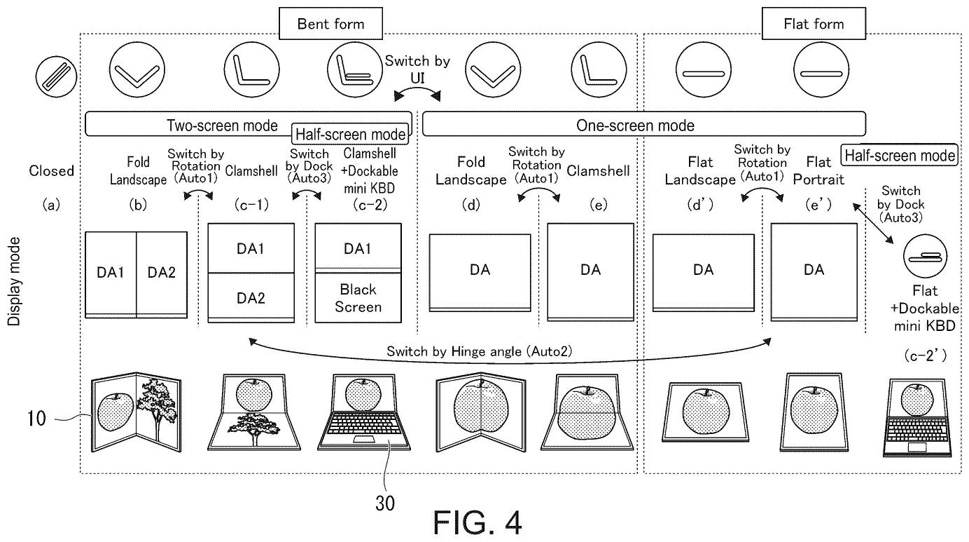

Referring next to FIG. 4, display modes by various usage forms of the information processing apparatus 10 will be described in detail.

FIG. 4 is a diagram illustrating specific examples of various display modes of the information processing apparatus 10 according to one or more embodiments. The display mode of the information processing apparatus 10 varies depending on the usage form classified by the open angle θ between the first chassis 101 and the second chassis 102, the posture (orientation) of the information processing apparatus 10, whether the mode is the one-screen mode or the two-screen mode, and the like. Note that one screen is also called a single screen, and two screens are also called spilt screens or dual screens.

Display mode (a) is a display mode when the first chassis 101 and the second chassis 102 are in the closed state (Closed) as the usage form. For example, in this closed state, the information processing apparatus 10 is in a standby state such as a sleep or hibernation state, and the display 150 is in a display-off state. This standby state such as the sleep or hibernation state corresponds, for example, to S3 or S4 as system power status defined in the ACPI (Advanced Configuration and Power Interface) specification.

Display mode (b) is a display mode in the bent state (Bent form) as the usage form and in the two-screen mode in which the display is controlled by splitting the screen area of the display 150 into the two display areas of the first display area DA1 and the second display area DA2. Further, the orientation of the information processing apparatus 10 is an orientation in which the first display area DA1 and the second display area DA2 are lined up side by side in portrait orientation. The portrait orientation of the display areas means an orientation in which long sides of the four sides of each of rectangular display areas are vertical and short sides are horizontal. When the display areas are in portrait orientation, the display orientation is also portrait orientation, and the display is provided in such an orientation that the direction along the long sides corresponds to the up-down direction and the direction along the short sides corresponds to the left-right direction. This usage form is a usage form in which left and right screens correspond to left and right pages when a book is opened, which corresponds to the so-called book mode. Since this usage form is the bent state (Bent form) and the display area obtained by combining the two display areas of the first display area DA1 and the second display area DA2 lined up side by side is horizontally long, it is also called “Fold Landscape.”

In this display mode (b), the information processing apparatus 10 is in a two-screen display mode in which the first display area DA1 on the left side is a primary screen and the second display area DA2 on the right side is a secondary screen, for example, in the normal operating state. Note that the correspondence relationship of the first display area DA1 and the second display area DA2 with the primary screen and the secondary screen in the display mode (b) may be reversed.

Like the display mode (b), display mode (c-1) is a display mode in the bent state (Bent form) and in the two-screen mode in which the display is controlled by splitting the screen area of the display 150 into the two display areas of the first display area DA1 and the second display area DA2, but the display mode (c-1) is a usage form different from the display mode (b) in terms of the orientation of the information processing apparatus 10. The orientation of the information processing apparatus 10 is an orientation in which the first display area DA1 and the second display area DA2 are vertically lined up and down in landscape orientation. The landscape orientation of the display areas means an orientation in which long sides of the four sides of each of the rectangular display areas are horizontal and short sides are vertical. When the display areas are in landscape orientation, the display orientation is also landscape, and the display is provided in such an orientation that the direction along the short sides corresponds to the up-down direction and the direction along the long sides corresponds to the left-right direction. This usage form is one of typical usage forms of a clamshell PC.

In this display mode (c-1), the information processing apparatus 10 is in the two-screen display mode in which the first display area DA1 is the primary screen and the second display area DA2 is the secondary screen, for example, in the normal operating state. Note that the correspondence relationship of the first display area DA1 and the second display area DA2 with the primary screen and the secondary screen in the display mode (c-1) may be reversed.

For example, the information processing apparatus 10 detects a change in the posture (orientation) of the information processing apparatus 10 to automatically switch from the display mode (b) to the display mode (c-1) or from the display mode (c-1) to the display mode (b) (Switch by Rotation). For example, since the display mode (c-1) is in such a state that the display 150 is rotated 90 degrees to the right from the state of the display mode (b) in FIG. 4, the information processing apparatus 10 switches to the display mode (c-1) when detecting the rotation of a predetermined angle (for example, 45 degrees) or more to the right from the state of the display mode (b). Further, since the display mode (b) is in such a state that the display 150 is rotated 90 degrees to the left from the state of the display mode (c-1) in FIG. 4, the information processing apparatus 10 switches to the display mode (b) when detecting the rotation of a predetermined angle (for example, 45 degrees) or more to the left from the state of the display mode (c-1).

Like the display mode (c-1), display mode (c-2) is in the bent state (Bent form) and the orientation of the information processing apparatus 10 is the same, but it is different in that an external keyboard 30 (Dockable mini KBD (Keyboard)) connectable to the information processing apparatus 10 is connected. This usage form is in such a state that a physical keyboard 30 is connected in a general usage form of the clamshell PC. For example, the size of the keyboard 30 is almost equivalent to the size of the second display area DA2, and the keyboard 30 is configured to be mountable on the second display area DA2. As an example, magnets are provided inside the bottom (on the bottom edges) of the keyboard 30, and when the keyboard 30 is mounted on the second display area DA2, the magnets are attracted to metal parts of the inner surface edges of the second chassis 102 and fixed. Thus, the usage form becomes a usage form similar to that of a traditional clamshell PC with a physical keyboard originally provided thereon. Further, the information processing apparatus 10 and the keyboard 30 are connected, for example, through Bluetooth (registered trademark). In this display mode (c-2), since the keyboard makes the second display area DA2 invisible, the information processing apparatus 10 controls the second display area DA2 to black display or display off. In other words, this display mode (c-2) is a display mode in which only half of the screen is enabled to provide a display (hereinafter called a “half-screen mode”), which corresponds to a one-screen mode using only the first display area DA1.

For example, when detecting the connection with the external keyboard in the state of the display mode (c-1), the information processing apparatus 10 automatically switches from the display mode (c-1) to the display mode (c-2) (Switch by Dock).

Like the display mode (b), display mode (d) is in the bent state (Bent form) and the orientation of the information processing apparatus 10 is the same, but it is different in that the display mode (d) is the one-screen mode in which the display is controlled using the entire screen area of the display 150 as one display area DA. Although this usage form is different from the display mode (b) in that the display mode is the one-screen mode, since it is in the bent state (Bent form) and the display area DA is horizontally long, this usage form is also called “Fold Landscape.” The display area DA is in landscape orientation, and the display orientation is also landscape.

Here, switching between the one-screen mode and the two-screen mode in the bent state (Bent form) is performed, for example, with a user operation. For example, the information processing apparatus 10 displays an operating element as a UI (User Interface) capable of switching between the one-screen mode and the two-screen mode somewhere on the screen to switch from the display mode (b) to the display mode (d) based on an operation on the operating element (Switch by UI). A specific example of this display mode switching operation will be described later.

Like the display mode (c-1), display mode (e) is in the bent state (Bent form) and the orientation of the information processing apparatus 10 is the same, but it is different in that the display mode (e) is in the one-screen mode in which the display is controlled using the entire screen area of the display 150 as one display area DA. This usage form is different from the display mode (c-1) in that the display mode (e) is the one-screen mode, but the display mode (e) corresponds to a usage form of the clamshell PC from the bent state (Bent form) and the orientation of the information processing apparatus 10. The display area DA is in portrait orientation and the display orientation is also portrait.

For example, the information processing apparatus 10 detects a change in the posture (orientation) of the information processing apparatus 10 to automatically switch from the display mode (d) to the display mode (e), or from the display mode (e) to the display mode (d) (Switch by Rotation). For example, since the display mode (e) is in such a state that the display 150 is rotated 90 degrees to the right from the state of the display mode (d) in FIG. 4, the information processing apparatus 10 switches to the display mode (e) when detecting the rotation of a predetermined angle (for example, 45 degrees) or more to the right from the state of the display mode (d). Further, since the display mode (d) is in such a state that the display 150 is rotated 90 degrees to the left from the state of the display mode (e) in FIG. 4, the information processing apparatus 10 switches to the display mode (d) when detecting the rotation of a predetermined angle (for example, 45 degrees) or more to the left from the state of the display mode (e).

Like the display mode (d), display mode (d′) is the one-screen mode and the orientation of the information processing apparatus 10 is such an orientation that the display area DA is horizontally long, but it is different in that the information processing apparatus 10 is in the flat state (Flat form). The flat state (Flat form) is a state in which the open angle θ between the first chassis 101 and the second chassis 102 is substantially 180°. This usage form corresponds to the so-called tablet mode described with reference to FIG. 3. Since this usage form is in the flat state (Flat form) and the display area DA is horizontally long, it is also called “Flat Landscape.” This display mode (d′) is different from the display mode (d) only in the open angle θ between the first chassis 101 and the second chassis 102. Like in the display mode (d), the display area DA in the display mode (d′) is in landscape orientation and the display orientation is also landscape.

Like the display mode (e), display mode (e′) is the one-screen mode and the orientation of the information processing apparatus 10 is such an orientation that the display area DA is vertically long, but it is different in that the information processing apparatus 10 is in the flat state (Flat form). Since this usage form is in the flat state (Flat form) and the display area DA is vertically long, it is also called “Flat Portrait.” This display mode (e′) is different from the display mode (e) only in the open angle θ between the first chassis 101 and the second chassis 102. Like in the display mode (e), the display area DA in the display mode (e′) is in portrait orientation and the display orientation is also portrait.

For example, the information processing apparatus 10 detects a change in the posture (orientation) of the information processing apparatus 10 to automatically switch from the display mode (d′) to the display mode (e′), or from the display mode (e′) to the display mode (d′) (Switch by Rotation). For example, since the display mode (e′) is in such a state that the display 150 is rotated 90 degrees to the right from the state of the display mode (d′) in FIG. 4, the information processing apparatus 10 switches to the display mode (e′) when detecting the rotation of a predetermined angle (for example, 45 degrees) or more to the right from the state of the display mode (d′). Further, since the display mode (d′) is in such a state that the display 150 is rotated 90 degrees to the left from the state of the display mode (e′) in FIG. 4, the information processing apparatus 10 switches to the display mode (d′) when detecting the rotation of a predetermined angle (for example, 45 degrees) or more to the left from the state of the display mode (e′).

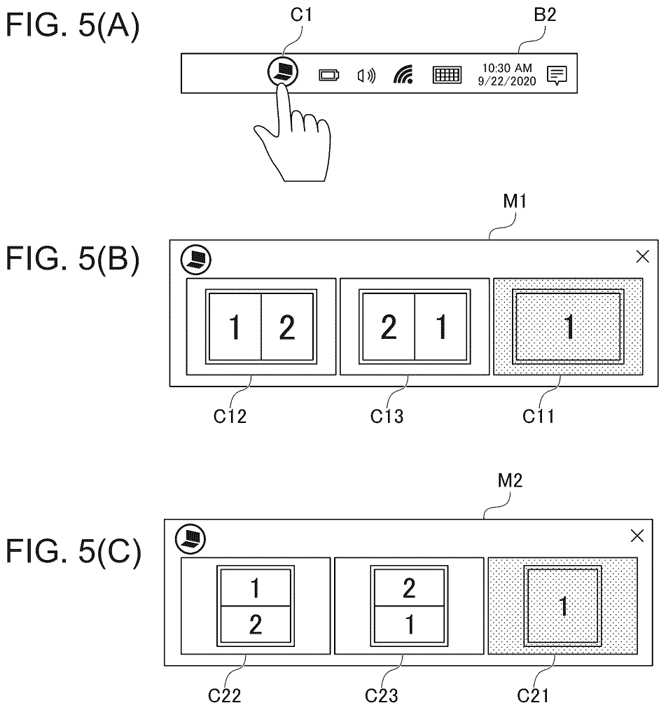

Note that in the display mode (d′) and the display mode (e′), it is also possible to switch to the two-screen mode while keeping the flat state (Flat form) by the user performing an operation on an operating element as the UI capable of switching between the one-screen mode and the two-screen mode described above (for example, on a display mode switching icon to be described later with reference to FIGS. 5(A)-(C)). For example, when switching to the two-screen mode from the state of the display mode (d′), the display state becomes similar to the display mode (b) in the flat state (Flat form). Further, when switching to the two-screen mode from the state of the display mode (e′), the display state becomes similar to the display mode (c-1) in the flat state (Flat form).

Further, when detecting the connection with the keyboard 30 in the state of the display mode (e′), the information processing apparatus 10 automatically switches from the display mode (e′) to display mode (c-2′) (Switch by Dock). The display mode (c-2′) is in the flat state (Flat form) and different from the display mode (c-2) only in the open angle θ between the first chassis 101 and the second chassis 102. In this display mode (c-2′), since the second display area DA2 becomes invisible by the keyboard, the information processing apparatus 10 controls the second display area DA2 to black display or display off. In other words, like the display mode (c-2), this display mode (c-2′) is the half-screen mode in which only one screen area as half of the entire screen area of the display 150 is enabled for display.

Further, the information processing apparatus 10 can also switch automatically from the one-screen mode to the two-screen mode by detecting a change from the flat state (Flat form) to the bent state (Bent form) (Switch by Hinge angle). For example, when detecting a change to the bent state (Bent form) in the state of the display mode (d′) based on the open angle θ between the first chassis 101 and the second chassis 102, the information processing apparatus 10 automatically switches from the display mode (d′) to the display mode (b). Further, when detecting a change to the bent state (Bent form) in the state of the display mode (e′) based on the open angle θ between the first chassis 101 and the second chassis 102, the information processing apparatus 10 automatically switches from the display mode (e′) to the display mode (c-1).

### (Display Mode Switching Operations)

Next, specific examples of operation specifications when switching between display modes with user operations will be described.

FIGS. 5(A)-(C) are diagrams illustrating an example of operation specifications of display mode switching operations according to one or more embodiments. For example, as illustrated in FIG. 5(A), an icon C1 to display a display mode switching menu is displayed on a task bar B2. The task bar B2 is displayed somewhere in the screen area of the display 150. For example, the task bar B2 is displayed only in one place inside the screen area of the display 150 (for example, at the bottom of the screen area) regardless of the one-screen mode or the two-screen mode. Note that in the case of the two-screen mode, the task bar B2 may also be displayed respectively in the first display area DA1 and the second display area DA2 (for example, at the bottoms of the respective display areas).

When an operation is performed on the icon C1 to display a switching menu, the display mode switching menu is displayed as a pop-up screen. Note that the display mode switching menu may also be displayed as a pop-up screen when the state of the information processing apparatus 10 changes from the bent state (Bent form) to the flat state (Flat form) in which the information processing apparatus 10 is not bent. Further, the display mode switching menu may be displayed as the pop-up screen when the state of the information processing apparatus 10 changes from the flat state (Flat form) to the bent state (Bent form).

On the switching menu, display mode switching icons for allowing the user to give instructions to switch between the one-screen mode and the two-screen mode, and to replace display data to be displayed respectively in the first display area DA1 and the second display area DA2 (to replace the primary screen and the secondary screen) are displayed as display mode options. On the switching menu, the display mode options selectable by the user depending on the usage form (the orientation of the display 150) at the time are displayed.

FIG. 5(B) illustrates a switching menu M1 displayed when the usage form is “Landscape” (the display mode (b), the display mode (d), the display mode (d′), or the like). Note that “1” and “2” in FIG. 5(B) are affixed to distinguish between the display areas, which are numbers, for example, according to the area priority preset for respective display areas. For example, in the two-screen mode, “1” is higher in area priority than “2.” For example, “1” indicates the primary screen, and “2” indicates the secondary screen. On the switching menu M1, a display mode switching icon C11, a display mode switching icon C12, and a display mode switching icon C13 are displayed. The display mode switching icon C11 is displayed as an operating element for selecting the display mode (d) or the display mode (d′) in the one-screen mode. The display mode switching icon C12 and the display mode switching icon C13 are displayed as operating elements for selecting the display mode (b) in the two-screen mode, where the display mode switching icon C12 and the display mode switching icon C13 are different in the order of “1” (primary screen) and “2” (secondary screen).

Note that a display mode switching icon corresponding to the current display mode is displayed in a display form distinguishable from the other display mode switching icons. Here, the display mode switching icon C11 is highlighted to distinguish from the other display mode switching icons C12 and C13 to make it clear that the display mode switching icon C11 is the current display mode.

FIG. 5(C) illustrates a switching menu M2 displayed when the usage form is “Clamshell” or “Portrait” (the display mode (c-1), the display mode (e), the display mode (e′), or the like). On the switching menu M2, a display mode switching icon C21, a display mode switching icon C22, and a display mode switching icon C23 are displayed. The display mode switching icon C21 is displayed as an operating element for selecting the one-screen mode (the display mode (e) or the display mode (e′)). The display mode switching icon C22 and the display mode switching icon C23 are displayed as operating elements for selecting the display mode (c-1) in the two-screen mode, where the display mode switching icon C22 and the display mode switching icon C23 are different in the order of “1” (primary screen) and “2” (secondary screen).

Note that, like the switching menu M1 illustrated in FIG. 5(B), a display mode switching icon corresponding to the current display mode is displayed on the switching menu M2 in a display form distinguishable from the other display mode switching icons. Here, the display mode switching icon C21 is highlighted to distinguish from the other display mode switching icons C22 and C23 to make it clear that the display mode switching icon C21 is the current display mode.

The user can select any of the display mode switching icons displayed on the switching menu M1 or the switching menu M2 arbitrarily. When the user selects any one of the display mode switching icons, the display of the switching menu is ended. Otherwise, when the user selects none of the display mode switching icons even after a predetermined time (for example, three to five seconds) has passed since the switching menu M1 or the switching menu M2 was displayed, the display of the switching menu is ended. Further, when the user presses a close button “x” at the top right of the switching menu, when the user performs an operation outside of the screen of the switching menu being popped up, or when the orientation of the information processing apparatus 10 is changed, the display of the switching menu is ended. Note that in the state where the keyboard 30 is connected, since the half-screen mode (display mode (c-2)) in which only the first display area DA1 is enabled for display is fixed, the switching menu is not displayed.

Note that the UI for switching between the one-screen mode and the two-screen mode is not limited to the example illustrated in FIGS. 5(A)-(C), and any other UI can be used. For example, an icon that alternately switches between the one-screen mode and the two-screen mode each time the icon is operated, or an icon that switches among the one-screen mode, the two-screen mode, and the reversed two-screen mode in order each time the icon is operated may be displayed on the task bar B2. In the following description, when there is no particular distinction between the two-screen mode and the reversed two-screen mode, both are collectively referred to as the two-screen mode.

Further, in the example illustrated in FIGS. 5(A)-(C), the display mode switching menu is displayed as the pop-up screen by the operation on the icon C1 displayed on the task bar B2, but the switching menu may also be displayed as a pop-up screen with a drag operation on an application window or the like. Further, the display mode may be switched with the drag operation on the application window or the like. When the switching menu is popped up with the drag operation on the application window, the application window may be dragged into one of split areas of a screen area displayed on the switching menu to make not only a screen mode but also a screen area selectable and to arrange the dragged application in the selected area. Further, the switching menu may be displayed as a pop-up screen with an operation on a specific location of the application window.

(Display Control Upon Switching from One-screen Mode to Two-screen Mode)

Next, display control upon switching from the one-screen mode to the two-screen mode will be described. When switching from the one-screen mode to the two-screen mode, the information processing apparatus 10 displays, in the first display area DA1 (for example, in the primary screen), one window among windows of applications (hereinafter simply called “apps”) running in the one-screen mode. For example, the information processing apparatus 10 displays, in the first display area DA1, an active window among the windows of the apps running in the one-screen mode.

Here, when multiple windows are open, the windows are layered and arranged in multiple layers on the display 150, respectively. The active window is a window currently selected as a user operation target, which is, for example, a window being arranged in and displayed on the frontmost layer (the top layer) of the display 150. The active window to be displayed in the first display area DA1 when the information processing apparatus 10 switches from the one-screen mode to the two-screen mode is a window that was being displayed as the active window in the one-screen mode just before switching to the two-screen mode.

Note that, when switching from the one-screen mode to the two-screen mode, the information processing apparatus 10 displays, in the first display area DA1, the active window in the one-screen mode. However, when there is no active window, the information processing apparatus 10 displays, in the first display area DA1, the highest priority window among the windows displayed in the display area DA in the one-screen mode.

Although the highest priority window is typically the active window, when there is no active window, the highest priority window is the last window in order of becoming the active window. For example, when an operation was performed on a location other than windows in the display area DA, the display area DA becomes a state where there is no active window. Therefore, the window that lastly became the active window is displayed in the first display area DA1. In other words, the later the order of becoming the active window, the higher the display priority, resulting in displaying the highest priority window in the first display area DA1. However, to make the description easier to understand, the following description will be made by stating the highest priority window as the “active window.”

Further, when switching from the one-screen mode to the two-screen mode, the information processing apparatus 10 displays, in the second display area DA2 (for example, in the secondary screen), thumbnail images (reduced images) corresponding to inactive windows except the active window among the windows in the one-screen mode. Here, the inactive windows are windows other than the active window in the one-screen mode just before the transition to the two-screen mode. In the following, a window with the thumbnail images of the inactive windows displayed therein is also called a “thumbnail window.”

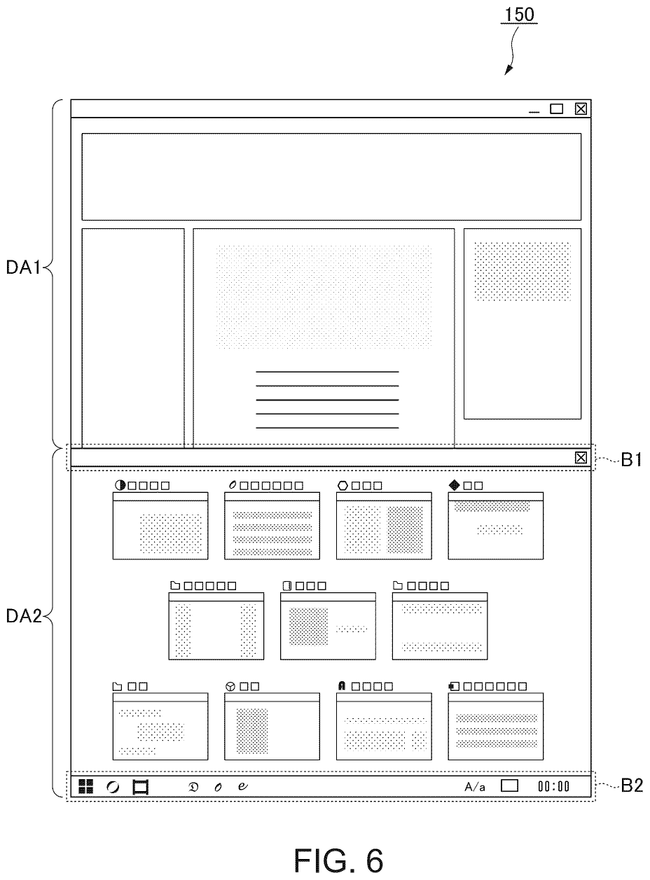

Referring to FIG. 6, a display example of the two-screen mode when the thumbnail window is displayed in the second display area DA2 after switching from the one-screen mode to the two-screen mode will be described.

FIG. 6 is a diagram illustrating a display example of the two-screen mode according to one or more embodiments. Here, the display example of the two-screen mode as the display mode (c-1) illustrated in FIG. 4 is illustrated. This usage form is a typical usage form of a clamshell PC in the two-screen mode, where the first display area DA1 and the second display area DA2 are vertically lined up and down in landscape orientation. The landscape orientation of the display areas means an orientation in which long sides of the four sides of each of the rectangular display areas are horizontal and short sides are vertical. The vertical corresponds to the vertical (up and down) direction, and the horizontal corresponds to the horizontal (left and right) direction. The vertical direction is typically the direction perpendicular to the ground. In other words, the first display area DA1 and the second display area DA2 are so arranged that the edge on the lower side in the display orientation of the first display area DA1 is on the lower side, and the edge on the upper side in the display orientation of the second display area DA2 is on the upper side.

When switching from the one-screen mode to the two-screen mode, the information processing apparatus 10 displays, in the first display area DA1, the active window of the app running in the one-screen mode. For example, when the transition to the two-screen mode is made, the information processing apparatus 10 maximizes and displays the active window, displayed in the display area DA in the one-screen mode, in the entire first display area DAL as the active window. Further, when the transition to the two-screen mode is made, the information processing apparatus 10 arranges windows as inactive windows in the one-screen mode on layers (lower layers) behind the frontmost layer on which the active window is displayed in the first display area DA1 while maintaining the layer relationship (the overlapping order of windows) in the one-screen mode. For example, the information processing apparatus 10 maximizes even windows as the inactive windows in the one-screen mode in the entire display area of the first display area DA1, and arranges the maximized windows on layers (lower layers) behind the active window. Therefore, in the first display area DA1, the active window is displayed as the maximized window, and the inactive windows are not displayed though existing on the layers (the lower layers) behind the active window (invisible to the user).

Further, when switching from the one-screen mode to the two-screen mode, the information processing apparatus 10 generates a thumbnail image of a window as an inactive window in the one-screen mode, and displays a thumbnail window in the second display area DA2 (on the secondary screen). When there are two or more inactive windows, the information processing apparatus 10 displays, in the second display area DA2, a thumbnail window in which thumbnail images of the two or more inactive windows are lined up.

For example, the thumbnail window is so displayed that the thumbnail images of the two or more windows are lined up in the thumbnail window. A title bar B1 is displayed at the top of the thumbnail window. A close button “x” at the right end of the title bar B1 is displayed as an operating element for closing the thumbnail window. The user can close the thumbnail window to make all the thumbnail images hidden by performing an operation (for example, a tap operation) on the close button “x” for this title bar B1.

Note that the inactive windows that exist on the layers behind the active window in the first display area DA1 (that is, the main bodies (real windows) of the inactive windows displayed as the thumbnail images in the second display area DA2) are overlaid one on top of the other in the order of priority in the same size (the maximized size in the entire display area of the first display area DA1) so that the inactive windows are hidden behind the active window, but the inactive windows may also be overlaid one on top of the other in the order of priority in a size smaller than the active window.

Further, the information processing apparatus 10 may minimize once all the main bodies (real windows) of the inactive windows displayed in the second display area DA2 as the thumbnail images (for example, a state where only icons of apps exist on the task bar in Windows (registered trademark)) without arranging them in the display area. In short, the main bodies (real windows) of the inactive windows with the thumbnail images displayed in the second display area DA2 have only to be processed to be once invisible to the user. Then, in the second display area DA2, a window of an app of a thumbnail image selected in the thumbnail window after that is displayed in the foreground as an active window.

Further, a task bar B2 displayed on the lower edge of the second display area DA2 corresponds to the task bar B2 illustrated in FIGS. 5(A)-(C), which is displayed in one place as a task bar common to the first display area DA1 and the second display area DA2. Note that the position at which the task bar B2 is displayed may be the left edge or the right edge of the first display area DA1 or the second display area DA2, or the upper edge of the first display area DA1. Further, as described above, task bars may be displayed in the first display area DA1 and the second display area DA2, respectively. No matter which position the task bar is displayed, the application of the present invention is not limited.

Note that FIG. 6 illustrates the example in which, when the thumbnail images are displayed in the second display area DA2, the thumbnail images are displayed as the thumbnail window with the title bar B1 contained therein, but there may be no display of the title bar B1, or the two or more thumbnail images may be simply displayed side by side.

When any one of the thumbnail images is selected with a user operation (for example, a tap operation), the information processing apparatus 10 closes (hides) the thumbnail window displayed in the second display area DA2, and displays, in the second display area DA2, an inactive window corresponding to the selected thumbnail image as an active window. Specifically, as an example, the information processing apparatus 10 moves the inactive window corresponding to the selected thumbnail image from the first display area DA1 to the second display area DA2, and maximizes and displays the inactive window in the second display area DA2 as an active window.

Thus, the user can easily display a window of an app that the user wants to use among running apps by selecting a thumbnail image. Here, when closing and hiding the window displayed in this second display area DA2, there may be no window display (the window may be empty). For example, as described with reference to FIG. 6, when the main bodies (real windows) of the inactive windows corresponding to the thumbnail images displayed in the second display area DA2 upon switching from the one-screen mode to the two-screen mode are arranged or minimized on lower layers of the first display area DA1, if the window displayed in the second display area DA2 is closed and hidden, there will be no window display in the second display area DA2 (the window will be empty). In this state, in order to display a window of another app in the empty second display area DA2, since operations to select the app, for example, from the task bar, display the window, and then move the window are required, the user cannot easily display the window.

Therefore, after closing and hiding the window displayed in the second display area DA2, the information processing apparatus 10 automatically displays the thumbnail window at the timing when the second display area DA2 becomes such a state that there is no window display (that the window is empty). Thus, the user can easily display a window of an app that the user wants to display next.

### (Thumbnail Window Display Control)

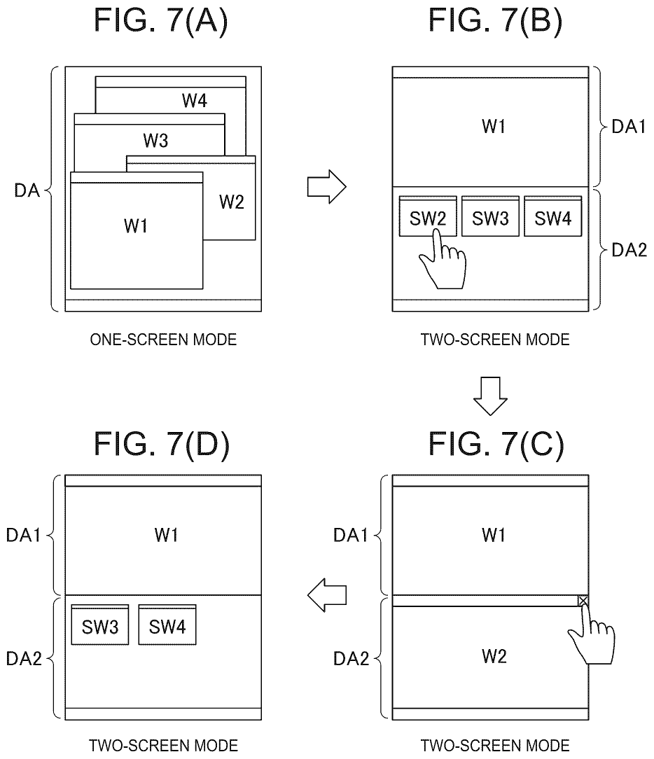

FIGS. 7(A)-(D) are diagrams illustrating a first example of thumbnail window display control according to one or more embodiments. FIG. 7(A) illustrates a display example of the one-screen mode. In the illustrated example, the number of windows of apps running in the one-screen mode is four. Here, four windows W1, W2, W3, and W4 are illustrated in the display area DA. The window W1 is an active window arranged on the frontmost layer. When switching from the one-screen mode to the two-screen mode, the window W1 is maximized and displayed as the active window in the first display area DA1, and a thumbnail window is displayed in the second display area DA2 as illustrated in FIG. 7(B).

For example, in the second display area DA2, a thumbnail window, in which thumbnail images SW2, SW3, and SW4 of the windows W2, W3, and W4 except the window W1 among the windows of the running apps are lined up, is displayed. The main bodies (real windows) of the windows W2, W3, and W4 are arranged or minimized on lower layers of the window W1 displayed in the first display area DA1. Note that, if the number of windows of apps running in the one-screen mode is five or more, the number of thumbnail images displayed in the second display area DA2 when switching to the two-screen mode will also be four or more.

When the user performs an operation to select the thumbnail image SW2 in the two-screen mode illustrated in FIG. 7(B), the thumbnail window is closed, and the window W2 corresponding to the thumbnail image SW2 is maximized and displayed as an active window in the second display area DA2 as illustrated in FIG. 7(C). Here, when the window W2 is closed and hidden with a user operation (for example, an operation on the close button “x” for the window W2), since no window is arranged on the lower layer of the window W2, the second display area DA2 becomes such a state that there is no window display (that the window is empty). Therefore, as illustrated in FIG. 7(D), a thumbnail window is automatically displayed in the second display area DA2. For example, in the second display area DA2, a thumbnail window, in which the thumbnail images SW3 and SW4 of the windows W3 and W4 except the window W1 among the windows of the running apps lined up, is displayed.

Note that, when the window W2 is minimized and hidden with use operations, rather than that the window W2 is closed and hidden with the user operation in FIG. 7(C), the window W2 also exists in a minimized state. Therefore, in this case, a thumbnail window in which the thumbnail images SW2, SW3, and SW4 are lined up is displayed in the second display area DA2 in FIG. 7(D).

Further, in the thumbnail window displayed in the second display area DA2 in FIG. 7(D), the thumbnail image of the window W1 being displayed in the first display area DA1 may also be contained. Further, when two or more displays are connected to the information processing apparatus 10, thumbnail images of windows being displayed on the other display(s) may also be contained in the thumbnail window displayed in the second display area DA2. In this case, when a thumbnail image of a window being displayed on any other display is selected, the window is moved to the second display area DA2 from the other display.

Further, even in a case where the window being displayed in the first display area DA1 is closed and hidden, the information processing apparatus 10 automatically displays a thumbnail window at the timing when the first display area DA1 becomes such a state that there is no window display (the window is empty).

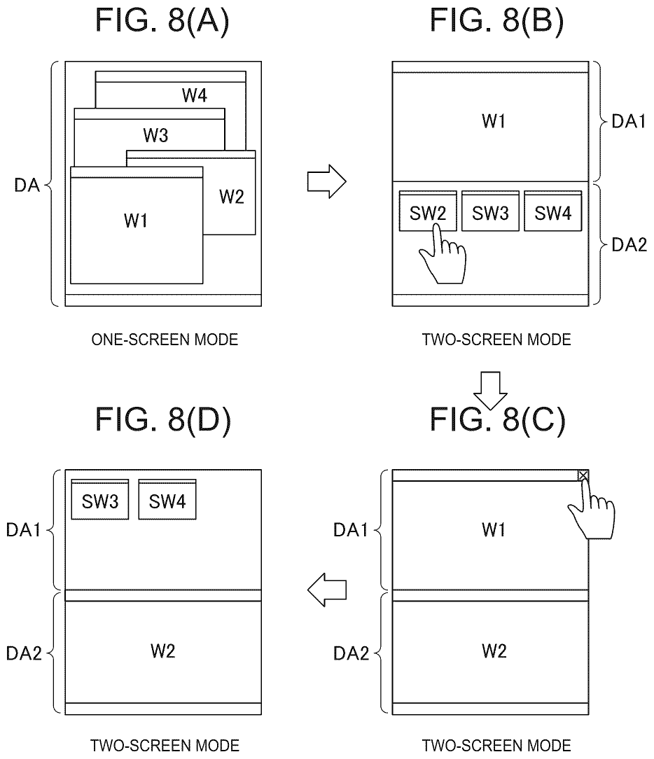

FIGS. 8(A)-(D) are diagrams illustrating a second example of thumbnail window display control according to one or more embodiments. FIG. 8(A) and FIG. 8(B) correspond to FIG. 7(A) and FIG. 7(B), respectively. When switching from the one-screen mode illustrated in FIG. 8(A) to the two-screen mode illustrated in FIG. 8(B), the window W1 is maximized and displayed as an active window in the first display area DA1, and the thumbnail window is displayed in the second display area DA2. Here, it is assumed that the main bodies (real windows) of the windows W2, W3, and W4 corresponding to the thumbnail images SW2, SW3, and SW4 being displayed in the second display area DA2 are minimized.

Further, when the user performs an operation to select the thumbnail image SW2 in the two-screen mode illustrated in FIG. 8(B), the thumbnail window is closed, and like in FIG. 7(C), the window W2 corresponding to the thumbnail image SW2 is maximized and displayed as the active window in the second display area DA2 as illustrated in FIG. 8(C).

Here, when the window W1 is closed and hidden with a user operation (for example, an operation on the close button “x” for the window W1), since no window is arranged on the lower layer of the window W1, the first display area DA1 becomes such a state that there is no window display (that the window is empty). Therefore, as illustrated in FIG. 8(D), a thumbnail window is automatically displayed in the first display area DA1. For example, in the first display area DA1, a thumbnail window, in which the thumbnail images SW3 and SW4 of the windows W3 and W4 except the window W2 among the windows of the running apps is lined up, is displayed.

Note that, when the window W1 is minimized and hidden with use operations, rather than that the window W1 is closed and hidden with the user operation in FIG. 8(C), the window W1 also exists in a minimized state. Therefore, in this case, a thumbnail window in which the thumbnail images SW1, SW3, and SW4 are lined up is displayed in the first display area DA1 in FIG. 8(D).

Further, in the thumbnail window displayed in the first display area DA1 in FIG. 8(D), the thumbnail image of the window W2 being displayed in the second display area DA2 may also be contained.

### (Configurations of Information Processing Apparatus 10)

Specific configurations of the information processing apparatus 10 will be described below.

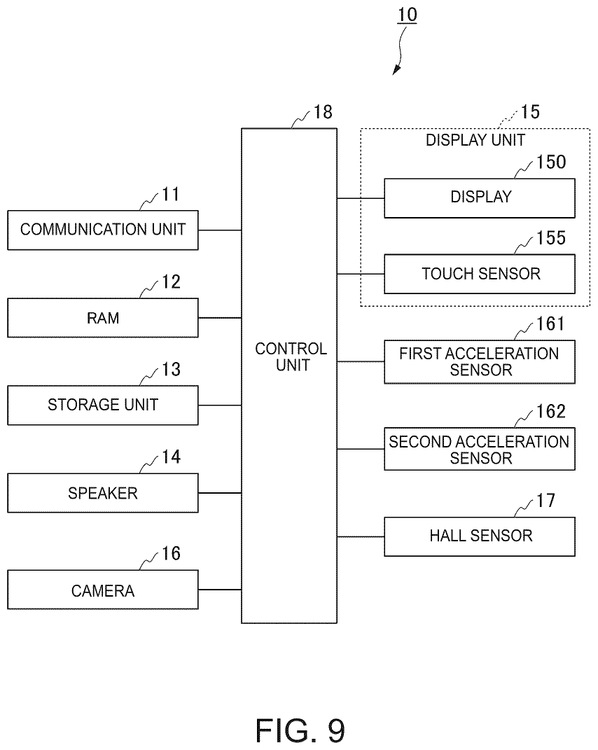

FIG. 9 is a block diagram illustrating an example of the hardware configuration of the information processing apparatus 10 according to one or more embodiments. The information processing apparatus 10 includes a communication unit 11, a RAM (Random Access Memory) 12, a storage unit 13, a speaker 14, a display unit 15, the camera 16, a first acceleration sensor 161, a second acceleration sensor 162, a Hall sensor 17, and a control unit 18. These units are communicably connected to one another through buses and the like.

The communication unit 11 is configured to include digital input/output ports such as two or more Ethernet (registered trademark) ports and two or more USB (Universal Serial Bus) ports, communication devices that perform wireless communication such as Bluetooth (registered trademark) and Wi-Fi (registered trademark), and the like. For example, the communication unit 11 can communicate with the above-described external keyboard 30 and the like using Bluetooth (registered trademark).

A program and data for processing executed by the control unit 18 are loaded into the RAM 12, and various data are stored or deleted appropriately. For example, the RAM 12 also functions as a video memory (V-RAM) for display of the display 150. As an example, the RAM 12 functions as a video memory for data to be displayed in each display area when the display 150 is controlled to the one-screen mode, the two-screen mode, or the like. Further, the RAM 12 stores information on running apps, information on an app in use among the running apps (an app of an active window) and inactive windows other than the app in use, information indicating in which of display areas each window is displayed and on which of layers the window is arranged, information on the size of the window and whether or not the window is minimized, and the like. Note that since the RAM 12 is a volatile memory, no data is retained when power supply to the RAM 12 is stopped. Data that must be retained when the power supply to the RAM 12 is stopped is transferred to the storage unit 13.

The storage unit 13 is configured to include any one or more of an SSD (Solid State Drive), an HDD (Hard Disk Drive), a ROM (Read Only Memory), a Flash ROM, and the like. For example, in the storage unit 13, a BIOS (Basic Input Output System) program and configuration data, an OS (Operating System), programs of apps running on the OS, various data used in the apps, and the like are stored.

The speaker 14 outputs electronic sound, voice, and the like.

The display unit 15 includes the display 150 and a touch sensor 155. As described above, the display 150 is a flexible display bendable to fit the open angle θ by relative rotation of the first chassis 101 and the second chassis 102. The display 150 provides a display corresponding to each display mode described with reference to FIG. 4 under the control of the control unit 18. The touch sensor 155 is provided on the screen of the display 150 to detect a touch operation on the screen. For example, in the case of the one-screen mode, the touch sensor 155 detects a touch operation in the display area DA. Further, in the case of the two-screen mode, the touch sensor 155 detects a touch operation(s) in either or both of the first display area DA1 and the second display area DA2. A tap operation, a slide operation, a flick operation, a swipe operation, a pinch operation, and the like are included in touch operations. The touch sensor 155 detects a touch operation and outputs, to the control unit 18, operation information based on the detected operation.

The camera 16 is configured to include a lens, an image sensor, and the like. The camera 16 captures images (still images and moving images) and outputs data of the captured images under the control of the control unit 18.

The first acceleration sensor 161 is provided inside the first chassis 101 to detect the orientation of the first chassis 101 and a change in the orientation of the first chassis 101. For example, assuming that a direction parallel to the long-side direction of the first display area DA1 is X1 direction, a direction parallel to the short-side direction is Y1 direction, and a direction perpendicular to the X1 direction and the Y1 direction is Z1 direction, the first acceleration sensor 161 detects respective accelerations along the X1 direction, the Y1 direction, and the Z1 direction, and outputs the detection results to the control unit 18.

The second acceleration sensor 162 is provided inside the second chassis 102 to detect the orientation of the second chassis 102 and a change in the orientation of the second chassis 102. For example, assuming that a direction parallel to the long-side direction of the second display area DA2 is X2 direction, a direction parallel to the short-side direction is Y2 direction, and a direction perpendicular to the X2 direction and the Y2 direction is Z2 direction, the second acceleration sensor 162 detects respective accelerations along the X2 direction, the Y2 direction, and the Z2 direction, and outputs the detection results to the control unit 18.

The Hall sensor 17 is provided to detect the connection of the keyboard 30. For example, when the keyboard 30 is mounted on the second display area DA2 of the second chassis 102, the magnetic field changes by the approach of the magnets provided inside the bottom of the keyboard 30 to change a detection value (output value) of the Hall sensor 17. In other words, the Hall sensor 17 outputs a detection result different depending on whether or not the keyboard 30 is mounted. Note that it is detected whether or not the keyboard 30 is mounted by using the Hall sensor 17 here, but the detection method is not limited thereto, and any other detection method can also be used.

The control unit 18 is configured to include processors such as a CPU (Central Processing Unit), a GPU (Graphic Processing Unit), and a microcomputer to realize various functions by executing programs (the BIOS, the OS, and various programs such as apps running on the OS) stored in the storage unit 13 and the like. For example, the control unit 18 detects the posture (orientation) of the information processing apparatus 10 based on the detection results of the first acceleration sensor 161 and the second acceleration sensor 162. Further, the control unit 18 detects whether the information processing apparatus 10 is in the open state or the closed state, whether the information processing apparatus 10 is in the bent state (Bent form) or the flat state (Flat form) in the case of the open state, and the like based on the detection results of the first acceleration sensor 161 and the second acceleration sensor 162.

Further, the control unit 18 detects a display mode switching operation by the user (for example, an operation on a display mode switching icon illustrated in FIGS. 5(A)-(C)). Further, the control unit 18 detects the connection with the keyboard 30 based on the detection result of the Hall sensor 17. Note that this connection with the keyboard 30 indicates the mounting of the keyboard 30 on the second display area DA2, and does not indicate communication connection. The control unit 18 detects the communication connection with the keyboard 30 using the function of Bluetooth (registered trademark) or the like.

Further, the control unit 18 detects the state of the system, the posture (orientation) of the information processing apparatus 10, whether the information processing apparatus 10 is in the open state or the closed state, and whether the information processing apparatus 10 is in the bent state (Bent form) or the flat state (Flat form) in the case of the open state, the display mode switching operation by the user (see FIGS. 5(A)-(C)), the connection with the keyboard 30, and the like to perform display control of the display 150 as described with reference to FIG. 4, and FIG. 6 to FIG. 9.

Next, a functional configuration related to display control processing among processing executed by the control unit 18 will be described.

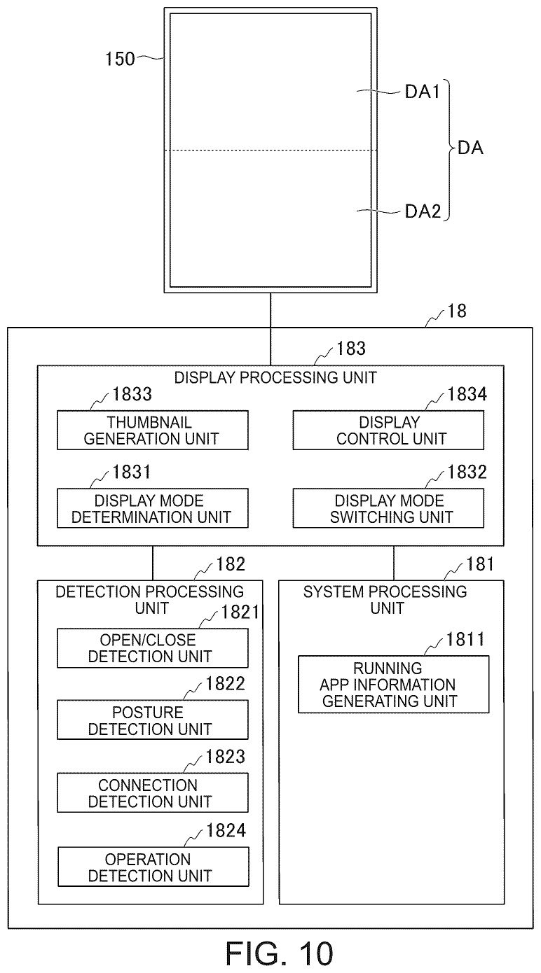

FIG. 10 is a block diagram illustrating an example of the functional configuration related to display control processing according to one or more embodiments. The control unit 18 includes a system processing unit 181, a detection processing unit 182, and a display processing unit 183. Here, the system processing unit 181 is a functional component in which the CPU executes processing based, for example, on the OS, the BIOS, or the like. Further, for example, the detection processing unit 182 is a functional component in which the microcomputer, different from the CPU that executes the processing of the OS or the BIOS, executes various detection processes. The display processing unit 183 is a functional component in which the CPU executes processing based, for example, on the OS or a program(s) running on the OS.

The system processing unit 181 executes the OS and various programs such as drivers and apps running on the OS. Further, for example, the system processing unit 181 includes a running app information generating unit 1811. The running app information generating unit 1811 generates app information including identification information on running apps (for example, app IDs), information indicative of an app in use by the user among the running apps (i.e., an app whose window is active), and the like. Further, the running app information generating unit 1811 generates window information indicative of the state of each of windows of the running apps. The state of the window is whether or not the window is an active window, the size (minimized or maximized) of the window, the position of the window and the layer on which the window is arranged, and the like. The running app information generating unit 1811 stores and retains the generated app information and window information in the RAM 12.

The detection processing unit 182 includes an open/close detection unit 1821, a posture detection unit 1822, and a connection detection unit 1823 as functional components to detect the state of the information processing apparatus 10. The detection processing unit 182 outputs, to the display processing unit 183, the detection results by the open/close detection unit 1821, the posture detection unit 1822, and the connection detection unit 1823.

The open/close detection unit 1821 detects whether the information processing apparatus 10 is in the open state or the closed state based on the detection results of the first acceleration sensor 161 and the second acceleration sensor 162. Further, when the information processing apparatus 10 is in the open state, the open/close detection unit 1821 detects the open angle θ between the first chassis 101 and the second chassis 102 based on the detection results of the first acceleration sensor 161 and the second acceleration sensor 162. Then, based on the detected open angle θ, the open/close detection unit 1821 detects whether the information processing apparatus 10 is in the bent state (Bent form) or the flat state (Flat form).

The posture detection unit 1822 detects the posture (orientation) of the information processing apparatus 10 based on the detection results of the first acceleration sensor 161 and the second acceleration sensor 162.

The connection detection unit 1823 detects the connection with the keyboard 30. For example, the connection detection unit 1823 detects whether or not the keyboard 30 is mounted on the second display area DA2 based on the detection result of the Hall sensor 17 to detect the connection with the keyboard 30. The detection processing unit 182 outputs, to the display processing unit 183, the detection results by the open/close detection unit 1821, the posture detection unit 1822, and the connection detection unit 1823 (that is, the state of the information processing apparatus 10).

Further, the detection processing unit 182 includes an operation detection unit 1824 as a functional component to detect an operation on the information processing apparatus 10. The operation detection unit 1824 detects a user operation based on operation information output from the touch sensor 155 provided on the screen of the display 150. For example, the operation detection unit 1824 acquires operation information based on a user operation on a switching menu (see FIGS. 5(A)-(C)) capable of switching the display mode to detect a display mode switching operation by the user to switch the display mode based on the acquired operation information. The detection processing unit 182 outputs the detected user operation information to the display processing unit 183.

Based on the open/closed state and the posture (orientation) of the information processing apparatus 10, the user operation, and the like acquired from the detection processing unit 182, the display processing unit 183 determines a display mode and switches to the display mode. Further, based on the app information acquired from the system processing unit 181, the display processing unit 183 controls the display of windows of running apps (an active window and inactive windows) depending on the display mode and the like. Specifically, the display processing unit 183 includes a display mode determination unit 1831, a display mode switching unit 1832, a thumbnail generation unit 1833, and a display control unit 1834.

The display mode determination unit 1831 performs determination processing to determine a display mode based on the detection result of the state of the information processing apparatus 10 or the user operation detected by the detection processing unit 182. For example, the display mode determination unit 1831 acquires, from the detection processing unit 182, the detection result of the open/closed state of the information processing apparatus 10, the detection result of whether the information processing apparatus 10 is in the bent state (Bent form) or the flat state (Flat form) in the case of the open state, the detection result of the posture (orientation) of the information processing apparatus 10, and the user operation information. Then, the display mode determination unit 1831 determines a display mode described with reference to FIG. 4 based on the respective detection results and the operation information acquired from the detection processing unit 182.

The display mode switching unit 1832 performs display mode switching processing to switch to a display mode as described with reference to FIG. 4 based on the display mode determined by the display mode determination unit 1831. For example, based on the display mode determined by the display mode determination unit 1831, the display mode switching unit 1832 switches among the one-screen mode, the two-screen mode (or the reversed two-screen mode), the half-screen mode, and the like, and sets a display mode such as the orientation of each display area and the display content of each display area.

The thumbnail generation unit 1833 generates thumbnail images corresponding to windows of running apps. For example, the thumbnail generation unit 1833 generates thumbnail images corresponding to inactive windows among the windows of the running apps as thumbnail images to be displayed as a thumbnail window in the second display area DA2 when switching from the one-screen mode to the two-screen mode. Further, the thumbnail generation unit 1833 generates thumbnail images to be displayed as a thumbnail window in the first display area DA1 or the second display area DA2 due to the fact that the first display area DA1 or the second display area DA2 is hidden. Note that the thumbnail generation unit 1833 basically generates thumbnail images that also contain minimized windows as inactive windows.

According to the display mode set by the display mode switching unit 1832, the display control unit 1834 performs display control processing to output display data on a window of an app or a thumbnail window to be displayed to each display area in order to display the display data.

When switching from the one-screen mode to the two-screen mode by the display mode switching unit 1832, the display control unit 1834 displays, in the first display area DA1, an active window (an active window that was displayed in the display area DA) among windows of apps running in the one-screen mode. For example, the display control unit 1834 maximizes the active window in the one-screen mode and displays the maximized window as the active window in the first display area DA1.

Further, when switching from the one-screen mode to the two-screen mode by the display mode switching unit 1832, the display control unit 1834 displays a thumbnail window in the second display area DA2. For example, the display control unit 1834 displays, in the second display area DA2, thumbnail images corresponding to inactive windows except the active window in the one-screen mode.

Here, when switching from the one-screen mode to the two-screen mode by the display mode switching unit 1832, the display control unit 1834 arranges the inactive windows except the active window in the one-screen mode on lower layers of the active window in the first display area DA1.

Note that, when switching from the one-screen mode to the two-screen mode by the display mode switching unit 1832, the display control unit 1834 may also minimize the inactive windows except the active window in the one-screen mode.

Further, when switching from one-screen mode to the two-screen mode by the display mode switching unit 1832, the display control unit 1834 may arrange the inactive windows except the active window in the one-screen mode once in the first display area DA1, and then minimize the inactive windows.

Note that, when there is only the active window without any inactive window in the one-screen mode, since there is no thumbnail image to be displayed in the second display area DA2 when switching from the one-screen mode to the two-screen mode, no thumbnail window is displayed, resulting in a state where the window is empty.

Further, when any one of the thumbnail images displayed in the second display area DA2 in the two-screen mode is selected with a user operation, the display control unit 1834 hides all the thumbnail images displayed in the second display area DA2, and displays an inactive window corresponding to the selected thumbnail image in the second display area DA2 as an active window. For example, the display control unit 1834 maximizes and displays the inactive window corresponding to the selected thumbnail image in the second display area DA2 as the active window.

Further, the display control unit 1834 displays a thumbnail window in a display area with the window hidden therefrom due to the fact that the window displayed in either the first display area DA1 or the second display area DA2 is hidden. For example, the display control unit 1834 displays thumbnail images (a thumbnail window) corresponding to at least some of windows of running apps in the display area with the window hidden therefrom. At this time, for example, the display control unit 1834 displays thumbnail images (a thumbnail window) corresponding to windows except a window displayed on the top layer of any one of two or more display areas among the windows of all the running apps.

Here, when displaying the thumbnail window due to the fact that the window displayed in either the first display area DA1 or the second display area DA2 is closed and hidden, the display control unit 1834 excludes, from display targets, a thumbnail image corresponding to the window that was closed and hidden. On the other hand, when displaying a thumbnail window due to the fact that a window displayed in either the first display area DA1 or the second display area DA2 is minimized and hidden, the display control unit 1834 also displays the thumbnail image corresponding to the window that was minimized and hidden.

Note that the display control unit 1834 may also display thumbnail images corresponding to the windows of all the running apps.

Further, when the window displayed in either the first display area DA1 or the second display area DA2 is hidden, and when there is no other window to be displayed in the display area with the window hidden therefrom (that is, when the window is empty), the display control unit 1834 displays a thumbnail window in the display area with the window hidden therefrom.

For example, the display control unit 1834 checks layers on which windows are arranged in each display area to check the presence or absence of a window arranged on a layer lower than the window that was hidden in the display area with the window hidden therefrom. The display control unit 1834 may acquire, from the system processing unit 181, information on layers on which windows are arranged in each display area, the display control unit 1834 itself may hold the information according to the display control, or the display control unit 1834 may use both information together. Then, when there is no window arranged on the lower layer in the display area with the window hidden therefrom, the display control unit 1834 determines that there is no other window to be displayed (that is, that the window is empty), and displays the thumbnail window.

### (Operation of Display Control Processing)

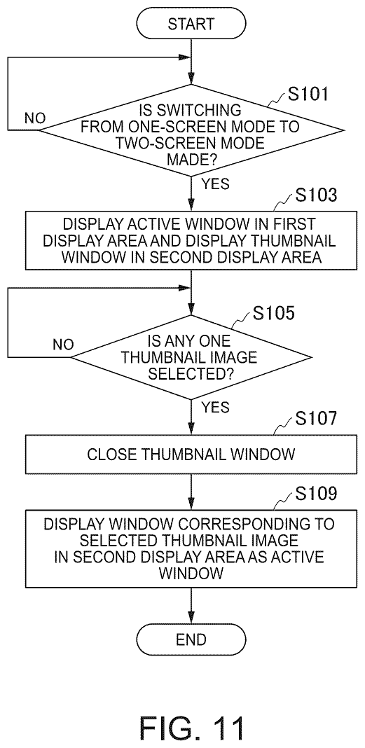

Next, the operation of display control processing by the control unit 18 will be described. First, the operation of display control processing in which the control unit 18 displays a thumbnail window when switching from the one-screen mode to the two-screen mode will be described with reference to FIG. 11.

FIG. 11 is a flowchart illustrating an example of display control processing upon switching to the two-screen mode according to one or more embodiments.

(Step S101) The control unit 18 determines whether or not to switch from the one-screen mode to the two-screen mode. For example, the control unit 18 determines whether or not to switch from the one-screen mode to the two-screen mode by detecting a change from the flat state (Flat form) to the bent state (Bent form) as described with reference to FIG. 4 or based on display mode switching operations described with reference to FIGS. 5(A)-(C). When determining that switching from the one-screen mode to the two-screen mode is not made (NO), the control unit 18 continues the one-screen mode, and performs the process in step S101 again. On the other hand, when determining that switching from the one-screen mode to the two-screen mode is made (YES), the control unit 18 switches to the two-screen mode in which the display area DA is split into two display areas of the first display area DA1 and the second display area DA2, and proceeds to a process in step S103.

(Step S103) The control unit 18 displays, in the first display area DA1, an active window in the one-screen mode, and displays, in the second display area DA2, a thumbnail window in which thumbnail images of inactive windows in the one-screen mode are lined up (for example, see FIG. 6, FIG. 7(B), and FIG. 8(B)). Then, the control unit 18 proceeds to a process in step S105.

(Step S105) The control unit 18 determines whether or not any one of the thumbnail images being displayed in the second display area DA2 is selected. When determining that no thumbnail image is selected (NO), the control unit 18 performs the process in step S105 again. On the other hand, when determining that any one of the thumbnail images is selected (YES), the control unit 18 proceeds to a process in step S107.

(Step S107) The control unit 18 closes the thumbnail window and ends the display of the thumbnail window. Then, the control unit 18 proceeds to a process in step S109.

(Step S109) The control unit 18 displays a window corresponding to the selected thumbnail image in the second display area DA2 as an active window (for example, maximizes and displays the window in the second display area DA2) (for example, see FIG. 7(C) and FIG. 8(C)).

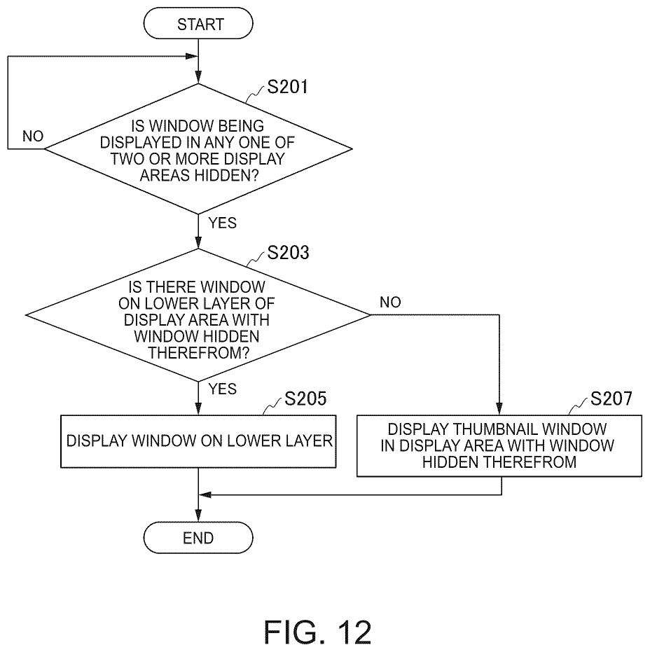

Next, the operation of display control processing in which the control unit 18 displays a thumbnail window due to the fact that a window displayed in either one of the display areas is hidden in the two-screen mode will be described with reference to FIG. 12.

FIG. 12 is a flowchart illustrating an example of display control processing when a window is hidden according to one or more embodiments.

(Step S201) The control unit 18 determines whether or not a window being displayed in either one of two or more display areas is hidden. For example, in the case of the two-screen mode, the control unit 18 determines whether or not a window being displayed in the first display area DA1 or the second display area DA2 is hidden. When determining that the window is not hidden (NO), the control unit 18 performs the process in step S201 again. On the other hand, when determining that the window is hidden (YES), the control unit 18 proceeds to a process in step S203.

(Step S203) The control unit 18 determines whether or not there is a window on a lower layer of the display area with the window hidden therefrom) (on the lower layer of the hidden window). When determining that there is a window on the lower layer (YES), the control unit 18 proceeds to a process in step S205. On the other hand, when determining that there is no window on the lower layer (NO), the control unit 18 proceeds to a process in step S207.

(Step S205) The control unit 18 displays a window on the lower layer in the display area with the window hidden therefrom. For example, when two or more windows are arranged on lower layers of the display area with the window hidden therefrom, the control unit 18 displays a window arranged on the highest layer among the windows.

(Step S207) The control unit 18 displays a thumbnail window in the display area with the window hidden therefrom (for example, see FIG. 7(D) and FIG. 8(D)).

As described above, the information processing apparatus 10 according to one or more embodiments includes: the display 150; the storage unit 13 (an example of a memory) which stores a program of an app (application); and the control unit 18 (an example of a processor such as the CPU, the GPU, and the microcomputer) which executes the program of the app stored in the storage unit 13 to perform control to display a window of the app on the display 150. The control unit 18 performs display mode switching processing to control switching between the one-screen mode (an example of a first display mode) to control display using the entire screen area of the display 150 as one display area DA, and the two-screen mode (an example of a second display mode) to control display by splitting the screen area of the display 150 into two display areas (for example, into the first display area DA1 and the second display area DA2). Further, the control unit 18 performs display control processing to display thumbnail images (for example, a thumbnail window) corresponding to at least some of windows of running apps in a display area with a window hidden therefrom due to the fact that the window displayed in either one of the two display areas in the two-screen mode is hidden.

Thus, for example, since the information processing apparatus 10 automatically displays thumbnail images of windows of other apps (for example, a thumbnail window) in the display area with the window closed and hidden therefrom, the information processing apparatus 10 can easily check any other running app to make it easy to switch to a window of any other app. Therefore, the information processing apparatus 10 can improve operability when selecting windows to be displayed in two or more display areas, respectively.

For example, when a window being displayed in either one of the two display areas (for example, the first display area DA1 and the second display area DA2) in the two-screen mode is hidden, and when there is no other window to be displayed in the display area with the window hidden therefrom (that is, when the window is empty), the control unit 18 displays, by the display control processing, the above thumbnail images (for example, the thumbnail window) in the display area with the window hidden therefrom.

Thus, for example, since the information processing apparatus 10 automatically displays thumbnail images of windows of other apps (for example, a thumbnail window) in the display area with the window closed and hidden therefrom, the information processing apparatus 10 can easily check any other running app to make it easy to switch to a window of the other app. Therefore, the information processing apparatus 10 can improve operability when selecting windows to be displayed in two or more display areas, respectively.

Further, when switching from the one-screen mode to the two-screen mode by the display mode switching processing, the control unit 18 displays, by the display control processing, an active window (an example of one window) among windows of apps running in the one-screen mode in the first display area DA1 of the two display areas, and displays, in the second display area DA2 except the first display area DA1 of the two display areas, thumbnail images (for example, a thumbnail window) corresponding to windows (for example, inactive windows) except the active window among the windows in the one-screen mode.

Thus, when switching from the one-screen mode to the two-screen mode, since the information processing apparatus 10 can not only display the active window on one screen but also display windows other than the active window on the other screen in a list of thumbnail images, the information processing apparatus 10 can easily check any other running app, and it is convenient.

Further, when switching from the one-screen mode to the two-screen mode by the display mode switching processing, the control unit 18 may also minimize, by the display control processing, the windows (for example, the inactive windows) except the active window among the windows in the one-screen mode.

Thus, for example, when the window is closed and becomes empty in any display area, the information processing apparatus 10 can automatically display thumbnail images of windows of the other apps (for example, a thumbnail window).

Further, when switching from the one-screen mode to the two-screen mode by the display mode switching processing, the control unit 18 may also minimize windows except the active window among the windows in the one-screen mode by the display control processing after being arranged in the first display area DA1.

Thus, for example, when displaying the minimized windows with an operation on the task bar, the information processing apparatus 10 can display the minimized windows on the side of the first display area DA1.

Further, when any one of the thumbnail images displayed in the second display area DA2 is selected with a user operation, the control unit 18 hides all the thumbnail images displayed in the second display area DA2, and displays a window corresponding to the selected thumbnail image in the second display area DA2.

Thus, the information processing apparatus 10 can easily display a window that the user wants to display only by the user selecting the thumbnail image.

For example, when displaying thumbnail images by the display control processing due to the fact that the window displayed in either one of the two display areas in the two-screen mode is hidden, the control unit 18 displays thumbnail images corresponding to windows except a window displayed on the top layer of either one of the two display areas among the windows of all the running apps.

Thus, the information processing apparatus 10 can easily check windows of apps not displayed in both of the display areas to make it easy to switch to a window of any other app.

Further, when displaying thumbnail images by the display control processing due to the fact that a window being displayed in either one of the two display areas in the two-screen mode is closed and hidden, the control unit 18 excludes, from display targets, a thumbnail image corresponding to the window that was closed and hidden.

Thus, the information processing apparatus 10 can prevent the thumbnail image of the closed window from being displayed by mistake.

Note that, when displaying the thumbnail images by the display control processing due to the fact that the window being displayed in either one of the two display areas in the two-screen mode is hidden, the control unit 18 may also display thumbnail images corresponding to the windows of all the running apps.

Thus, since the information processing apparatus 10 can display the windows of all the running apps in a list of thumbnail images, it is convenient. For example, the information processing apparatus 10 can also allow the user to easily display, in the second display area DA2, the window being displayed in the first display area DA1 and to check the window.

Further, a control method for the information processing apparatus 10 according to one or more embodiments includes: a display mode switching step of causing a processor to control switching between the one-screen mode (the example of the first display mode) to control display using the entire screen area of the display 150 as one display area DA, and the two-screen mode (the example of the second display mode) to control display by splitting the screen area of the display 150 into two display areas (for example, into the first display area DA1 and the second display area DA2); and a display control step of causing the processor to display thumbnail images (for example, a thumbnail window) corresponding to at least some of windows of running apps in a display area with a window hidden therefrom due to the fact that the window displayed in either one of the two display areas in the two-screen mode is hidden.

Thus, for example, since the information processing apparatus 10 automatically displays thumbnail images of windows of other apps (for example, a thumbnail window) in the display area with the window closed and hidden therefrom, the information processing apparatus 10 can easily check any other running app to make it easy to switch to a window of the other app. Therefore, the information processing apparatus 10 can improve operability when selecting windows to be displayed in two or more display areas, respectively.

### Second Embodiment

Next, an overview of a second embodiment of the present invention will be described.

In the above-described embodiments, such a configuration that the information processing apparatus 10 has the one-screen mode to control display using the entire screen area of the display 150 as one display area DA, and the two-screen mode to control display by splitting the screen area of the display 150 into two display areas of the first display area DA1 and the second display area DA2 is described, but the information processing apparatus 10 may also control display by splitting the screen area of the display 150 into three or more display areas.

In one or more embodiments, in addition to the one-screen mode and the two-screen mode, the information processing apparatus 10 has a three-screen mode to control display by splitting the screen area of the display 150 into three display areas, and a four-screen mode to control display by splitting the screen area of the display 150 into four display areas. Like in the two-screen mode, even in the three-screen mode or the four-screen mode, the information processing apparatus 10 can perform display control processing to display a thumbnail window due to the fact that a window displayed in either one of multiple display areas is hidden.

Note that the basic configurations of the information processing apparatus 10 are the same as those in the above-described embodiments, and examples of display control in the three-screen mode and the four-screen mode will be described here.

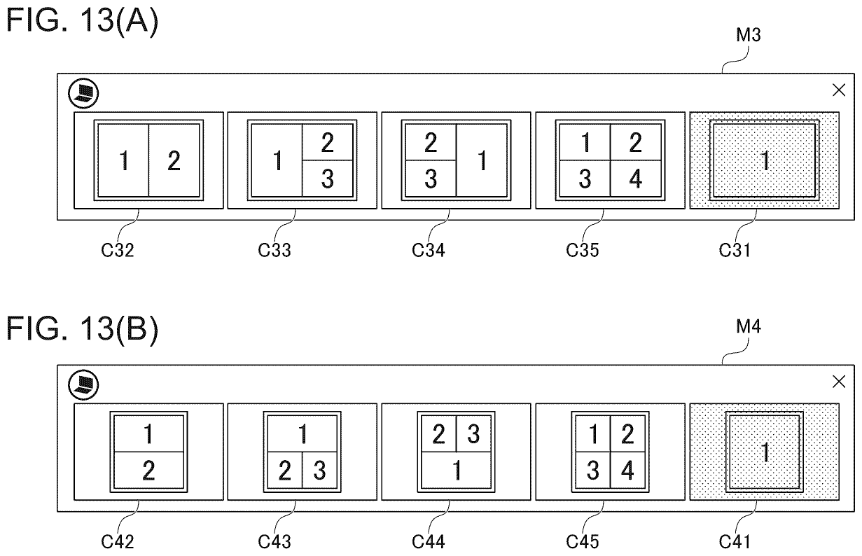

FIGS. 13(B)-(C) are diagrams illustrating an example of operation specifications of display mode switching operations according to one or more embodiments. FIGS. 13(B)-(C) illustrates an example of switching menus displayed by performing, for example, the operation on the icon C1 illustrated in FIG. 5(A). FIG. 13(B) illustrates a switching menu M3 displayed when the usage form is “Landscape” (the display mode (b), the display mode (d), the display mode (d′), or the like), and FIG. 13(C) illustrates a switching menu M4 when the usage form is “Clamshell” or “Portrait” (the display mode (c-1), the display mode (e), the display mode (e′), or the like). The switching menu M3 and the switching menu M4 are different respectively from the switching menu M1 in FIG. 5(B) and the switching menu M2 in FIG. 5(C) in that the switching menu M3 and the switching menu M4 can switch to the three-screen mode and the four-screen mode.

On the switching menu M3, display mode switching icons C31, C32, C33, C34, and C35 are displayed. The display mode switching icon C31 is displayed as an operating element for selecting the display mode (d) or the display mode (d′) in the one-screen mode. The display mode switching icon C32 is displayed as an operating element for selecting the display mode (b) in the two-screen mode. The display mode switching icon C33 and the display mode switching icon C34 are displayed as operating elements for selecting display modes in the three-screen mode, respectively. The display mode switching icon C33 and the display mode switching icon C34 are different in whether the first display area DA1 or the second display area DA2 in the two-screen mode is split into two display areas. The display mode switching icon C35 is displayed as an operating element for selecting a display mode in the four-screen mode.

Like in FIGS. 5(A)-(C), “1,” “2,” “3,” and “4” in FIGS. 13(B)-(C) are affixed to distinguish among the display areas, which are numbers, for example, according to the area priority preset for respective display areas. “1” is the highest area priority, and the area priority goes down in the order of “2,” “3,” and “4.”

When the user performs an operation to select the display mode switching icon C33 or the display mode switching icon C34, the display of the switching menu is ended, and control is made to the three-screen mode in “Landscape.” Further, when the user performs an operation to select the display mode switching icon C35, the display of the switching menu is ended, and control is made to the four-screen mode in “Landscape.”

On the switching menu M4, display mode switching icons C41, C42, C43, C44, and C45 are displayed. The display mode switching icon C41 is displayed as an operating element for selecting the display mode (e) or the display mode (e′) in the one-screen mode. The display mode switching icon C42 is displayed as an operating element for selecting the display mode (c-1) in the two-screen mode. The display mode switching icon C43 and the display mode switching icon C44 are displayed as operating elements for selecting display modes in the three-screen mode, respectively. The display mode switching icon C43 and the display mode switching icon C44 are different in whether the first display area DA1 or the second display area DA2 in the two-screen mode is split into two display areas. The display mode switching icon C45 is displayed as an operating element for selecting a display mode in the four-screen mode.

When the user performs an operation to select the display mode switching icon C43 or the display mode switching icon C44, the display of the switching menu is ended, and control is made to the three-screen mode in “Clamshell” or “Portrait.” Further, when the user performs an operation to select the display mode switching icon C45, the display of the switching menu is ended, and control is made to the four-screen mode in “Clamshell” or “Portrait.”

### (Thumbnail Window Display Control in Three-screen Mode)

Next, thumbnail window display control in the three-screen mode will be described. Here, respective areas when the screen area of the display 150 is split into three display areas in the three-screen mode are called a first display area DA1, a second display area DA2, and a third display area DA3.

Note that it can also be said that the second display area DA2 and the third display area DA3 in the three-screen mode are two second display areas obtained by splitting the display area except the first display area DA1 is split into two display areas. In order to distinguish between the two second display areas, the two second display areas are illustrated as the second display area DA2 and the third display area DA3 in order of area priority from the top.

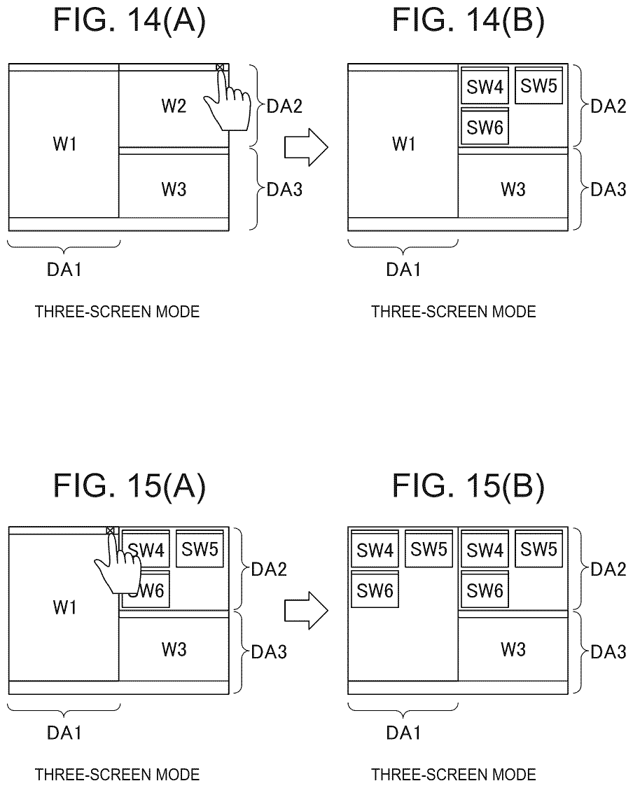

FIGS. 14(A)-(B) are diagrams illustrating a first example of thumbnail window display control in the three-screen mode according to one or more embodiments. FIG. 14(A) illustrates an example in which window W1 is displayed in the first display area DA1, window W2 is displayed in the second display area DA2, and window W3 is displayed in the third display area DA3, respectively, in the three-screen mode. Here, it is assumed that the number of windows of running apps is six, that is, windows W1, W2, W3, W4, W5, and W6, and the windows W4, W5, and W6 are arranged or minimized on lower layers of the window W1 in the first display area DA1.

In FIG. 14(A), when the window W2 is closed and hidden with a user operation (for example, an operation on the close button “x” for the window W2), since no window is arranged on the lower layer of the window W2, the second display area DA2 becomes such a state that there is no window display (that the window is empty). Therefore, as illustrated in FIG. 14(B), a thumbnail window is automatically displayed in the second display area DA2. For example, in the second display area DA2, a thumbnail window is displayed where thumbnail images SW4, SW5, and SW6 of the windows W4, W5, and W6 except the windows W1 and W3 among the windows of running apps are lined up.

Note that, when the window W2 is minimized and hidden with a user operation in FIG. 14(A), rather than that the window W2 is closed and hidden with the user operation, the window W2 also exists in a minimized state. Therefore, in FIG. 14(B), a thumbnail window is displayed in the second display area DA2 where the thumbnail images SW2, SW4, SW5, and SW6 are lined up.

Further, in FIG. 14(B), the thumbnail image of the window W1 displayed in the first display area DA1 and the thumbnail image of the window W3 displayed in the third display area DA3 may also be contained in the thumbnail window displayed in the second display area DA2.

FIGS. 15(A)-(B) are diagrams illustrating a second example of thumbnail window display control in the three-screen mode according to one or more embodiments. FIG. 15(A) corresponds to the display example of FIG. 14(B). The window W1 and the window W3 are displayed in the first display area DA1 and the third display area DA3, respectively, and the thumbnail window is displayed in the second display area DA2. Further, in this example illustrated in FIGS. 15(A)-(B), it is assumed that the main bodies (real windows) of the windows W4, W5, and W6 corresponding to the thumbnail images SW4, SW5, and SW6 displayed in the second display area DA2 are minimized.

In FIG. 15(A), when the window W1 is closed and hidden with a user operation (for example, an operation on the close button “x” for the window W1), since no window is arranged on the lower layer of the window W1, the first display area DA1 becomes such a state that there is no window display (that the window is empty). Therefore, as illustrated in FIG. 15(B), a thumbnail window is automatically displayed in the first display area DA1. For example, in the first display area DA1, a thumbnail window is displayed where the thumbnail images SW4, SW5, and SW6 of the window W4, W5, and W6 except the window W3 among the windows of the running apps are lined up.

Note that, when the window W1 is minimized and hidden with a user operation in FIG. 15(A), rather than that the window W1 is closed and hidden with the user operation, the window W1 also exists in a minimized state. Therefore, in FIG. 15(B), a thumbnail window is displayed in the first display area DA1 where the thumbnail images SW1, SW2, SW4, SW5, and SW6 are lined up.

Further, in FIG. 15(B), the thumbnail image of the window W3 displayed in the third display area DA3 may also be contained in the thumbnail window displayed in the first display area DA1.

### (Thumbnail Window Display Control in Four-screen Mode)

Next, thumbnail window display control in the four-screen mode will be described. Here, respective areas when splitting the screen area of the display 150 into four display areas in the four-screen mode are called a first display area DA1, a second display area DA2, a third display area DA3, and a fourth display area DA4.

Note that it can also be said that the second display area DA2, the third display area DA3, and the fourth display area DA4 in the four-screen mode are three second display areas obtained by splitting the display area except the first display area DA1 into three display areas. In order to distinguish among the three second display areas, the three second display areas are illustrated as the second display area DA2, the third display area DA3, and the fourth display area DA4 in order of area priority from the top.

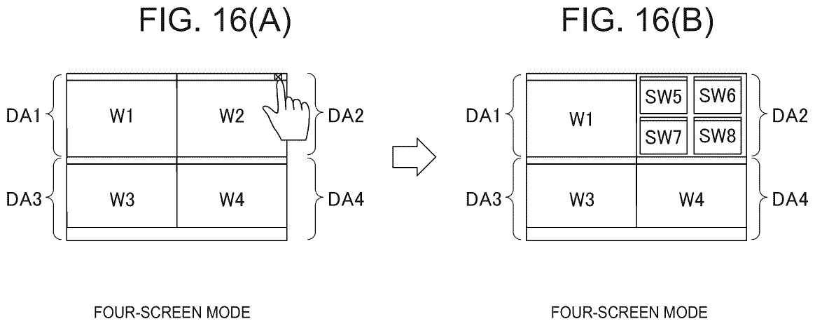

FIG. 16 is a diagram illustrating an example of thumbnail window display control in the four-screen mode according to one or more embodiments. FIG. 16(A) illustrates an example in which window W1 is displayed in the first display area DA1, window W2 is displayed in the second display area DA2, window W3 is displayed in the third display area DA3, and window W4 is displayed in the fourth display area DA4, respectively, in the four-screen mode. Here, it is assumed that the number of windows of running apps is eight, that is, windows W1, W2, W3, W4, W5, W6, W7, and W8, and the windows W5, W6, W7, and W8 are arranged or minimized on lower layers of the window W1 in the first display area DA1.

In FIG. 16(A), when the window W2 is closed and hidden with a user operation (for example, an operation on the close button “x” for the window W2), since no window is arranged on the lower layer of the window W2, the second display area DA2 becomes such a state that there is no window display (that the window is empty). Therefore, as illustrated in FIG. 16(B), a thumbnail window is automatically displayed in the second display area DA2. For example, in the second display area DA2, a thumbnail window is displayed where thumbnail images SW5, SW6, SW7, and SW8 of the windows W5, W6, W7, and W8 except the windows W1, W3, and W4 among the windows of the running apps are lined up.

Note that, when the window W2 is minimized and hidden with a user operation in FIG. 16(A), rather than that the window W2 is closed and hidden with the user operation, the window W2 also exists in a minimized state. Therefore, in FIG. 16(B), a thumbnail window is displayed in the second display area DA2 where the thumbnail images SW2, SW5, SW6, SW7, and SW8 are lined up.

Further, in FIG. 16(B), the thumbnail image of the window W1 displayed in the first display area DA1, the thumbnail image of the window W3 displayed in the third display area DA3, and the thumbnail image of the window W4 displayed in the fourth display area DA4 may also be contained in the thumbnail window displayed in the second display area DA2.

As described above, in the information processing apparatus 10 according to one or more embodiments, the control unit 18 performs display mode switching processing to control switching between the one-screen mode (the example of the first display mode) to control display using the entire screen area of the display 150 as one display area DA, and a multi-screen mode (another example of the second display mode) to control display by splitting the screen area of the display 150 into multiple (two, three, four, or the like) display areas. Further, the control unit 18 performs display control processing to display thumbnail images (for example, a thumbnail window) corresponding to at least some of windows of running apps in a display area with a window hidden therefrom due to the fact that the window displayed in any one of the multiple display areas in the multi-screen mode is hidden.

Thus, for example, since the information processing apparatus 10 automatically displays thumbnail images of windows of other apps (for example, a thumbnail window) in the display area with the window closed and hidden therefrom, the information processing apparatus 10 can easily check any other running app to make it easy to switch to a window of the other app. Therefore, the information processing apparatus 10 can improve operability when selecting windows to be displayed in multiple display areas, respectively.

For example, when a window displayed in any one of the multiple display areas in the multi-screen mode is hidden, and when there is no other window to be displayed in the display area with the window hidden therefrom, the control unit 18 displays, by the display control processing, thumbnail images (for example, a thumbnail window) in the display area with the window hidden therefrom.

Thus, for example, since the information processing apparatus 10 automatically displays thumbnail images of windows of other apps (for example, a thumbnail window) in the display area with the window closed and hidden therefrom, the information processing apparatus 10 can easily check any other running app to make it easy to switch to a window of the other app. Therefore, the information processing apparatus 10 can improve operability when selecting windows to be displayed in multiple display areas, respectively.

For example, when displaying thumbnail images by the display control processing due to the fact that a window displayed in any one of the multiple display areas in the multi-screen mode is hidden, the control unit 18 displays thumbnail images corresponding to windows except a window displayed on the top layer of any one of the multiple display areas among windows of all running apps.

Thus, the information processing apparatus 10 can easily check windows of apps not displayed in any display area to make it easy to switch to a window of another app.

Further, when displaying thumbnail images by the display control processing due to the fact that a window displayed in any one of the multiple display areas in the multi-screen mode is closed and hidden, the control unit 18 excludes, from display targets, a thumbnail image corresponding to the window closed and hidden.

Thus, the information processing apparatus 10 can prevent the thumbnail image of the closed window from being displayed by mistake.

Note that, when displaying the thumbnail images by the display control processing due to the fact that a window displayed in any one of the multiple display areas in the multi-screen mode is hidden, the control unit 18 may also display thumbnail images corresponding to windows of all running apps.

Thus, since the information processing apparatus 10 can display the windows of all the running apps in a list of thumbnail images, it is convenient. For example, the information processing apparatus 10 can also allow the user to easily display the window, displayed in any one of the display areas, in another display area and to check the window.

Further, a control method for the information processing apparatus 10 according to one or more embodiments includes: a display mode switching step of causing the processor to control switching between the one-screen mode (the example of the first display mode) to control display using the entire screen area of the display 150 as one display area DA, and a multi-screen mode (another example of the second display mode) to control display by splitting the screen area of the display 150 into multiple (two, three, four, or the like) display areas; and a display control step of causing the processor to display thumbnail images (for example, a thumbnail window) corresponding to at least some of windows of running apps in any one of the multiple display areas with the window hidden therefrom due to the fact that the window displayed in the display area in the multi-screen mode is hidden.

Thus, for example, since the information processing apparatus 10 automatically displays thumbnail images of windows of other apps (for example, a thumbnail window) in the display area with the window closed and hidden therefrom, the information processing apparatus 10 can easily check any other running app to make it easy to switch to a window of the other app. Therefore, the information processing apparatus 10 can improve operability when selecting windows to be displayed in multiple display areas, respectively.

While the embodiments of this invention have been described in detail above with reference to the accompanying drawings, the specific configurations are not limited to those described above, and various design changes and the like can be made without departing from the scope of this invention. For example, the configurations described in the respective embodiments mentioned above may be combined arbitrarily.

Note that, in the aforementioned embodiments, the example in which, when a window displayed in any one of display areas in the multi-screen mode (for example, the two-screen mode, the three-screen mode, or the four-screen mode) is hidden, and when the display area becomes such a state that there is no window display (that the window is empty), a thumbnail window (thumbnail images) is displayed is described, but the thumbnail window (the thumbnail images) may also be displayed even when there is a window on the lower layer of the display area and the window is not empty. For example, in the display control processing illustrated in FIG. 12, when determining in step S201 that the window is hidden (YES), the control unit 18 may proceed to the process in step S207 without performing the determination process in step S203 to display the thumbnail window in the display area with the window hidden therefrom.

Further, in the embodiments described above, the example in which the foldable one display 150 is used in the one-screen mode and the two-screen mode is described, but two displays may also be used. In other words, the processing in the embodiments described above can also be applied to switching between a one-screen mode in which display is controlled by combining respective screen areas of the two displays into one display area, and a two-screen mode in which display is controlled using the respective screen areas of the two displays individually as display areas. Further, the processing in the embodiments described above can be applied to the three-screen mode or the four-screen mode in which display is controlled by splitting one or both of the respective screen areas of the two displays into two display areas.

Further, in the embodiments described above, the configuration of the information processing apparatus 10 having, as the multi-screen mode, the two-screen mode in which display is controlled by splitting the display area into two display areas, the three-screen mode in which display is controlled by splitting the display area into three display areas, and the four-screen mode in which display is controlled by splitting the display area into four display areas is described, but the information processing apparatus 10 may also be configured to have a screen mode in which display is controlled by splitting the display area into five or more display areas.

Further, in the embodiments described above, the example of touch operations on the multi-touch panel type display constructed by integrating the input unit (touch sensor) and the display unit together is described, but the operations are not limited to the touch operations, which may also be click operations with a mouse, operations with gestures, and the like.

Note that the control unit 18 described above has a computer system therein. Then, a program for implementing the function of each component included in the control unit 18 described above may be recorded on a computer-readable recording medium so that the program recorded on this recording medium is read into the computer system and executed to perform processing in each component included in the control unit 18 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the control unit 18, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the functions of the control unit 18 in the embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

10 information processing apparatus
101 first chassis
102 second chassis
103 hinge mechanism
11 communication unit
12 RAM
13 storage unit
14 speaker
15 display unit
16 camera
150 display
155 touch sensor
161 first acceleration sensor
162 second acceleration sensor
17 Hall sensor
18 control unit
181 system processing unit
1811 running app information generating unit
182 detection processing unit
1821 open/close detection unit
1822 posture detection unit
1823 connection detection unit
1824 operation detection unit
183 display processing unit
1831 display mode determination unit
1832 display mode switching unit
1833 thumbnail generation unit
1834 display control unit

What is claimed is:

1. An information processing apparatus comprising:
a display;
a memory which stores a program of an application; and
a processor which executes the program of the application stored in the memory to perform control to display a window of the application on the display, wherein
the processor performs
display mode switching processing to control switching between a first display mode in which display is controlled using an entire screen area of the display as one display area, and a second display mode in which display is controlled by splitting the screen area of the display into multiple display areas, and
display control processing to display thumbnail images corresponding to at least some of windows of running applications in any one of the multiple display areas with a window hidden therefrom due to a fact that the window being displayed in the display area in the second display mode is hidden.

2. The information processing apparatus according to claim 1, wherein when the window being displayed in any one of the multiple display areas in the second display mode is hidden and when there no other window to be displayed in the display area with the window hidden therefrom, the processor displays, by the display control processing, the thumbnail images in the display area with the window hidden therefrom.

3. The information processing apparatus according to claim 1, wherein when switching from the first display mode to the second display mode by the display mode switching processing, the processor displays one window among the windows of the applications running in the first display mode in a first display area among the multiple display areas by the display control processing, and displays, in a second display area except the first display area among the multiple display areas, the thumbnail images corresponding to windows except the one window among the windows in the first display mode.

4. The information processing apparatus according to claim 3, wherein when switching from the first display mode to the second display mode by the display mode switching processing, the processor minimizes, by the display control processing, the windows except the one window among the windows in the first display mode.

5. The information processing apparatus according to claim 4, wherein when switching from the first display mode to the second display mode by the display mode switching processing, the processor arranges, in the first display area, and then minimizes the windows except the one window among the windows in the first display mode by the display control processing.

6. The information processing apparatus according to claim 3, wherein when any one of the thumbnail images is selected with a user operation, the processor hides all the thumbnail images displayed in the second display area, and displays a window corresponding to the selected thumbnail image in the second display area.

7. The information processing apparatus according to claim 1, wherein when displaying the thumbnail images by the display control processing due to the fact that the window being displayed in any one of the multiple display areas in the second display mode is hidden, the processor displays the thumbnail images except a window being displayed on a top layer in any one of the multiple display areas among the windows of all the running applications.

8. The information processing apparatus according to claim 1, wherein when displaying the thumbnail images by the display control processing due to the fact that the window being displayed in any one of the multiple display areas in the second display mode is closed and hidden, the processor excludes, from display targets, a thumbnail image corresponding to the window closed and hidden.

9. The information processing apparatus according to claim 1, wherein when displaying the thumbnail images by the display control processing due to the fact that the window being displayed in any one of the multiple display areas in the second display mode is hidden, the processor displays the thumbnail images corresponding to the windows of all the running applications.

10. A control method for an information processing apparatus including: a display; a memory which stores a program of an application; and a processor which executes the program of the application stored in the memory to perform control to display a window of the application on the display, the control method comprising:
a display mode switching step of causing the processor to control switching between a first display mode in which display is controlled using an entire screen area of the display as one display area, and a second display mode in which display is controlled by splitting the screen area of the display into multiple display areas; and
a display control step of causing the processor to display thumbnail images corresponding to at least some of windows of running applications in any one of the multiple display areas with a window hidden therefrom due to a fact that the window being displayed in the display area in the second display mode is hidden.
